(19) United States
(12) Patent Application Publication
(10) Pub. No.: US 2020/0356567 A1
(43) Pub. Date: Nov. 12, 2020

(54) SEARCH CIRCUIT

(71) Applicant: RENESAS ELECTRONICS CORPORATION, Tokyo (JP)

(72) Inventor: Hideto MATSUOKA, Tokyo (JP)

(21) Appl. No.: 16/834,877

(22) Filed: Mar. 30, 2020

(30) Foreign Application Priority Data
May 10, 2019 (JP) 2019-089736

(51) Int. Cl. G06F 16/2455

(52) U.S. Cl. CPC G06F 16/24558

(57) ABSTRACT

A search circuit capable of efficiently executing a search process while suppressing an increase in memory chips is provided. The search circuit includes a first memory, a second memory and a processor which executes a binary search with the first and the second memory. The plurality of entry data are divided into a two search stage groups according to a reading order position of a binary search and are stored in the first and the second memory for each groups. The second memory includes a plurality of memory banks provided according to the number of search stages of the corresponding group. The memory banks each stores entry data for each search stages.

### CROSS-REFERENCE TO RELATED APPLICATIONS

The disclosure of Japanese Patent Application No. 2019-089736 filed on May 10, 2019 including the specification, drawings and abstract is incorporated herein by reference in its entirety.

### BACKGROUND

The present disclosure relates to a search circuit for searching a search table in which a plurality of entry data are stored for a match between input search keys.

With the progress of IT, there is a need for an application that searches for a location where specific data of interest is stored from a large-capacity database at high speed. For example, in order to determine a path from an IP address serving as a destination to a target terminal in the Internet, a database search is performed in which a destination IP address is used as search data and a route to a destination is output as a search result. When searching specified data from such database, there is a system called linear search in which data is sequentially searched until the target data is found. When data matching the search data Key is searched from the set Y having N elements, the search is performed by the following algorithm.

TABLE 1
For(i=1; i<=N; i=i+1){
If(Y[i]==Key) break;
}

| | | | | | | |
|---|---|---|---|---|---|---|
| Number of Search times | 1 | 2 | 3 | N-2 | N-1 | N |
| Search element | Y[1] | Y[2] | Y[3] | Y[N-2] | Y[N-1] | Y[N] |

As described above, each element of the set is sequentially searched one by one, and when the target data is found, the search is finished.

Therefore, the worst case of the linear search is a case where the target data is the final element Y[N] of the set, and N times search operations are required. Therefore, as the number of elements in the database increases, the search performance deteriorates.

On the other hand, binary search is one of methods for performing search faster than linear search.

There is disclosed techniques listed below.

[Patent Document 1] U.S. Pat. No. 6,549,519

As a technique for speeding up a binary search, Patent Document 1 discloses a method of setting memory addresses to be accessed in each of memory accesses and dividing each of the memory addresses into different memory instances so as to pipeline the binary search processing, thereby speeding up a search performance.

When search table for a large-scale binary search is constructed, a general-purpose memory chip such as a dedicated DRAM or SRAM is generally used for the data of the search table instead of the built-in memory of ASIC or FPGA.

Therefore, when pipelining according to Patent Document 1 is performed for high speed, as many memory chips as the number of memory instances are required.

Also, each memory chip requires a separate memory bus to and from the processor to implement pipelining operations.

In such a mounting method, there arises a problem that the mounting area of the board is increased and the control of the processor for controlling the memory is complicated.

### SUMMARY

The present disclosure has been made to solve the above-mentioned problems and provides a search circuit capable of efficiently executing a search process while suppressing an increase in memory chips even when a search table is scaled up.

Other objects and novel features will become apparent from the description of this specification and the accompanying drawings.

A search circuit for determining matching between a search key and entry data using binary search comprises a first memory, a second memory and a processor. The processor performs a binary search operation by using the first and the second memory. The first memory comprises entry data corresponding to a first search stage group of a plurality of search stages. The second memory comprises entry data corresponding to a second search stage group of the search stages. The second memory includes a plurality of memory banks provided according to number of the search stages of the second search stage group. The entry data corresponding to the second search stage group are divided into a plurality of sub-entry data groups for each search stages of the second search stage group. The entry data of each sub-entry data groups is stored in each the memory banks based on the search stages.

According to one Embodiment, even when the search table is increased in size, the search circuit of the present disclosure can efficiently execute a search process while suppressing an increase in memory chips.

### BRIEF DESCRIPTION OF THE DRAWINGS

FIG. 1 is a diagram illustrating a configuration of a communication device 1 based on a first embodiment.

FIG. 2 is a diagram illustrating an access procedure of a binary search according to a comparative example.

FIGS. 3A and 3B are diagrams illustrating a pipelining of a binary research according to a comparative example.

FIGS. 4A and 4B are diagrams for explaining a general DRAM memory chip.

FIG. 5 is a diagram illustrating a case in which data is stored in a memory bank according to a comparative example.

FIG. 6 is a diagram illustrating an outline of the search algorithms for binary search according to first embodiment.

FIG. 7 is a diagram for explaining the entry data group of 1M addresses according to first embodiment.

FIG. 8 is a diagram for explaining the operations of the first processing unit 502 and the built-in memory 503 according to first embodiment.

FIG. 9 is diagram illustrating operations of the second processing unit 504, the interface circuit 505, and the memory 506 according to first embodiment.

FIG. 10 is a diagram illustrating a search operation of a plurality of search keys K0 to K3 according to first embodiment.

FIG. 11 is a diagram (part 1) that explains the timing chart of the search operation for a plurality of search keys according to first embodiment.

FIG. 12 is a diagram illustrating a search operation of a plurality of search keys K0 to K6 according to first embodiment.

FIG. 13 is a diagram (part 2) illustrating a timing chart of a search operation of a plurality of search keys according to first embodiment.

FIG. 14 is a diagram illustrating a search operation of a plurality of search keys K0 to K24 according to first embodiment.

FIG. 15 is a diagram (part 3) illustrating a timing chart of a search operation of a plurality of search keys according to first embodiment.

FIG. 16 is a diagram illustrating an outline of the search algorithms for binary search according to second embodiment.

FIG. 17 is a diagram illustrating an outline of the search algorithms for binary search according to third embodiment.

FIG. 18 is a diagram illustrating the operations of the second processing unit 1104, the interface circuit 1105, and the memory 1106 according to third embodiment.

FIG. 19 is a diagram illustrating a search operation of a plurality of search keys K0 to K7 according to third embodiment.

FIG. 20 is a diagram (part 1) that explains the timing chart of the search operation for a plurality of search keys according to third embodiment.

FIG. 21 is a diagram illustrating a search operation of a plurality of search keys K0 to K15 according to third embodiment.

FIG. 22 is a diagram (part 2) illustrating a timing chart of a search operation of a plurality of search keys according to third embodiment.

FIG. 23 is a diagram illustrating a search operation of a plurality of search keys K0 to K23 according to third embodiment.

FIG. 24 is a diagram (part 3) illustrating a timing chart of a search operation of a plurality of search keys according to third embodiment.

FIG. 25 is a diagram illustrating an outline of the search algorithms for binary search according to modified example of third embodiment.

FIG. 26 is a diagram illustrating an outline of the search algorithms for binary search according to second modified example of third embodiment.

### DETAILED DESCRIPTION

The invention will be now described herein with reference to illustrative embodiments. In the drawings, the same or corresponding components are denoted by the same reference numerals, and description thereof will not be repeated.

### First Embodiment

### <Configuration of Communication Device>

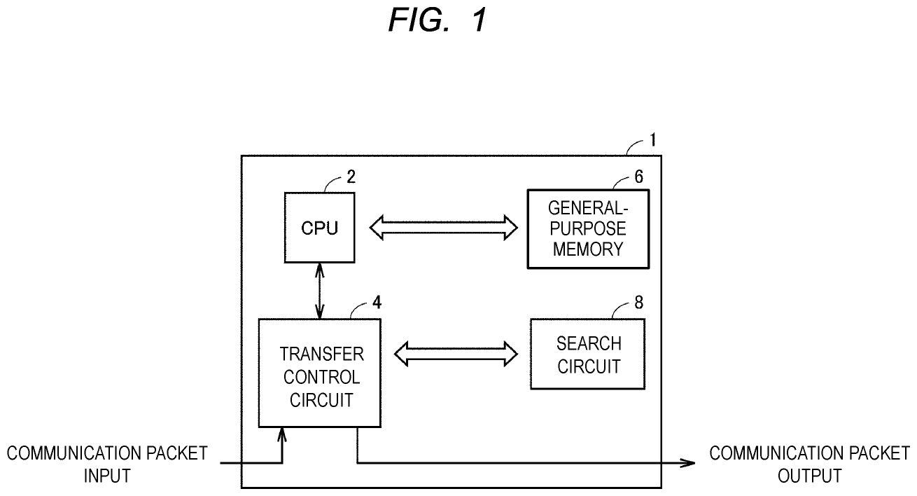

FIG. 1 is a diagram illustrating a configuration of a communication device 1 according to a first embodiment.

As shown in FIG. 1, the communication device 1 is a communication device such as a switch or a router. The communication device 1 is connected to the Internet. The communication device 1 executes a transfer processing of packet data.

The communication device 1 includes a central processing unit (Central Processing Unit) 2, a transfer control circuit 4, a general-purpose memory 6, and a search circuit 8.

CPU 2 controls the entire device. CPU 2 realizes various functions in cooperation with programs stored in the general-purpose memory 6. For example, the general-purpose memory 6 can be configured with DRAM (Dynamic Random Access Memory), and the operating system (OS) is constructed by cooperating with CPU 2. CPU 2 exchanges information with neighboring communication devices and the like, and maintains and manages information required for the transfer processing.

The transfer control circuit 4 executes a transfer processing of the communication packet. The transfer control circuit 4 is provided with a ASIC (Application Specific Integrated Circuit) specialized for the transfer processing or dedicated hardware such as an NPU (Network Processing Unit). The transfer control circuit 4 accesses the search circuit 8 to acquire information necessary for the transfer processing.

### <Search Algorithm of Binary-Search According to Comparative Example>

In the binary search, data of a set to be searched is sorted in an ascending order in advance, and the search operation is repeated until data matching a target search data is found by the following algorithm.

```
TABLE 2
i=N/2
For(j=4; i<=N; j=j*2){
  If(Y[i]==Key) break;}
  else if (Y[i]>Key){i=i+N/j}
  else {i=i−N/k}
}
```

| | | | | | | |
|---|---|---|---|---|---|---|
| Number of | 1 | 2 | 3 | K-2 | K-1 | K |
| Search times | | | | | | |
| Search element | Y[N/2] | Y[N/4] | Y[N/8] | Y[4] | Y[2] | Y[1] |

When Log₂(N)=K is defined as the number of times of referring to search table of the binary search with N elements, a single search operation by binary search requires K times of access to the memory stored the search table of the binary search.

Here, assuming N=15, since K=Log₂(15)=4, a maximum number of memory accesses required for a single search operation by the binary search is four.

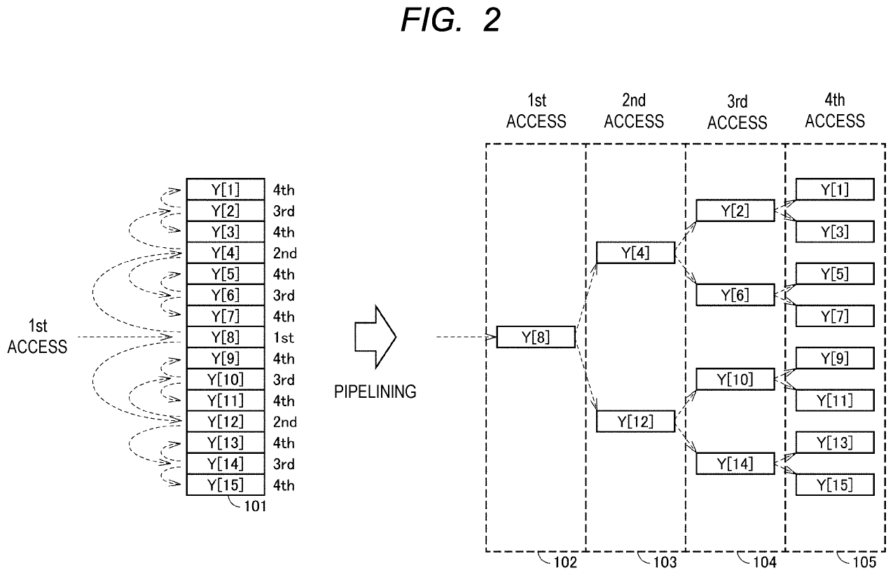

FIG. 2 is a diagram illustrating an access procedure of a binary search according to a comparative example. As shown in the left side of FIG. 2, when 15 sorted elements Y[1] to Y[15] are stored in the memory 101, the binary search is executed in the access order as shown by the broken line.

As shown in right side of FIG. 2, in order to pipeline the binary search, each access stage (search stage) is stored in the memory. Specifically, the element Y[8] is stored in the memory 102. The elements Y[4] and Y[12] are stored in the memory 103. The elements Y[2], Y[6], Y[10], and Y[14] are stored in the memory 104. The elements Y[1], Y[3], Y[5], Y[7], Y[9], Y[11], Y[13], and Y[15] are stored in the memory 105.

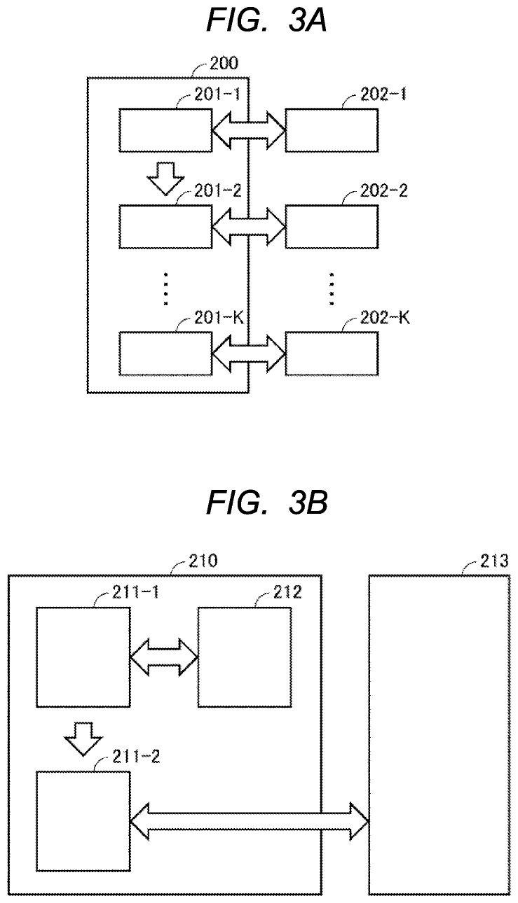

FIGS. 3A and 3B are diagrams illustrating pipelining of a binary search according to a comparative example. As shown in FIG. 3A, in order to pipeline a binary search which requires K memory accesses using a memory chip such as a DRAM, it is required to provide K memories 202-1 to 202-K and processing units 201-1 to 201-K of the processor 200 for accessing the memories 202-1 to 202-K.

Then, K memory buses for connecting the memory 202 and the processing unit 201 are also required.

However, as described above, the number of memory chips increases, and the control of the processor 200 is complicated by an increase in the mounting area of the board and an increase in the number of pins of the processor 200 for controlling the memory.

Therefore, when constructing large-scale binary search, it is conceivable to pipeline part rather than all of the binary search.

In FIG. 3B, the pipeline processing is divided into two stages, and the data of the pre-stage portions of the number of access stages (search stage) from 1 to K/2 stages are stored in the built-in memory 212 of the processor 210 for executing the binary search. Then, the data of remaining number of access stages (search stages) from ((K/2)+1) to K stages is stored in the memory chip 213.

With this configuration, it is possible to suppress an increase in the number of memory chips. However, in FIG. 3A, since the K stages of binary search is pipelined, the search performance is K times as compared with the case without pipelining, but in FIG. 3B, since only two stages are pipelined, the search performance is only twice as high.

When the search table for the binary search to be searched is large-scale, a general-purpose memory such as a DRAM or a SRAM is generally used as the memory used in FIG. 3B and the like.

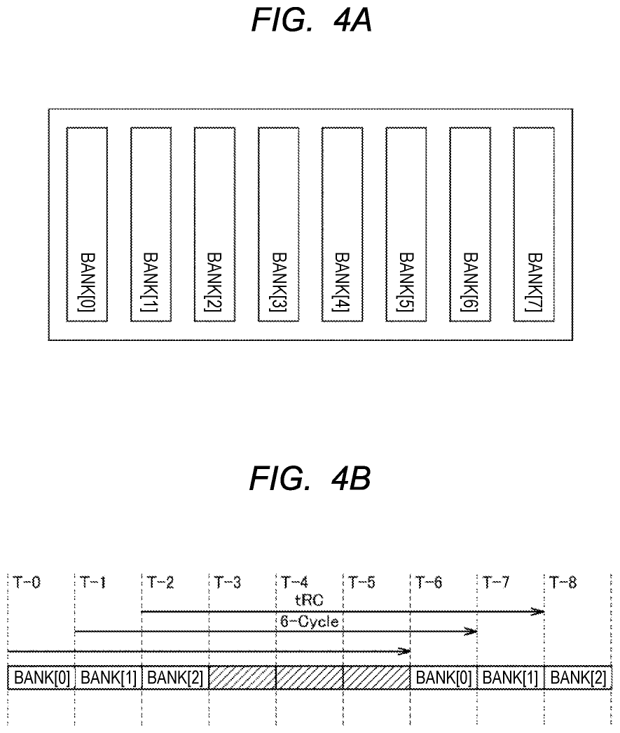

FIGS. 4A and 4B are diagrams for explaining a general DRAM memory chip. FIG. 4A shows a case where the DRAM memory chip is divided into a plurality of memory banks. As examples, the case where the memory chip is divided into memory banks BANK[0] to BANK[7] is shown.

In a general DRAM memory chip, since a precharge period or the like needs to be provided, a time constraint is set for accessing the same memory bank.

Specifically, access to the same memory bank is prohibited for a predetermined waiting time tRC.

FIG. 4B shows a case in which accesses to the same memory bank are prohibited for six cycles.

As shown in the present embodiment, when accesses to the same memory bank are concentrated, the waiting time tRC frequently occurs, and thus the search performance may deteriorate.

In this case, a case is shown in which the same memory bank cannot be accessed due to the waiting time tRC between cycles T-3 and T-5.

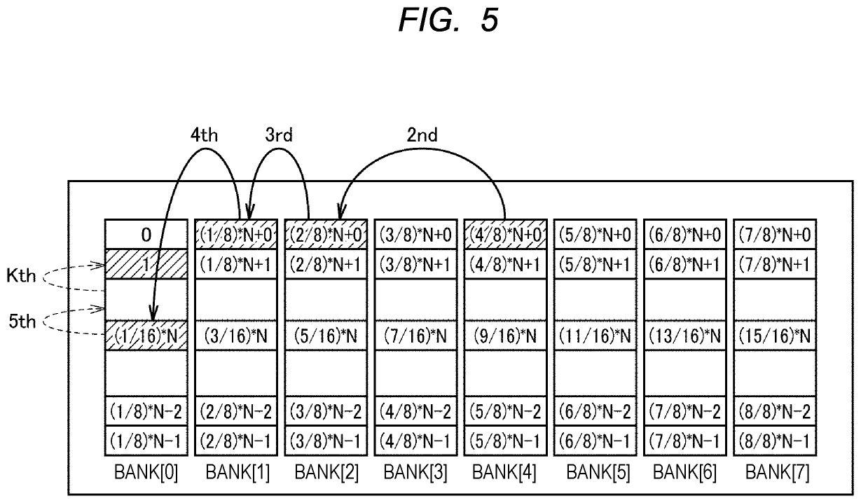

FIG. 5 is a diagram illustrating a case where data is stored in a memory bank according to a comparative example.

As shown in FIG. 5, data is stored in the memory banks BANK[0] to BANK[7] described in FIG. 4.

For example, N pieces of data are stored in the order of sorting from memory address 0. The memory address 0 is the top address of the memory bank BANK[0]. The last of the memory addresses is the last address of the memory banks BANK[7].

The order of accesses when the binary search using the plurality of memory banks is performed will be described.

Here, binary search is executed in the order of accesses predefined by the binary search algorithms shown in Table 2. The memory bank BANK[4] is accessed first, then the memory bank BANK[2] is accessed, and then the memory bank BANK[1] is accessed. Then, the memory bank BANK[0] is accessed. After the fourth memory accesses, accesses concentrate on the same memory bank BANK[0].

In this case, the search performance deteriorates due to the influence of the waiting time tRC as described above.

### <Search Algorithm of Binary Search According to the First Embodiment>

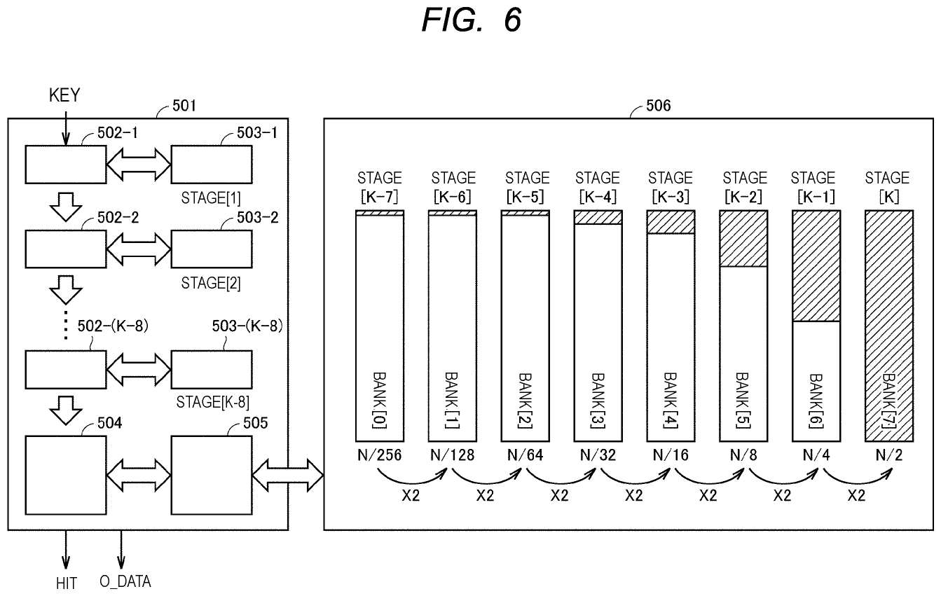

FIG. 6 is a diagram illustrating an outline of a search algorithm of binary search according to the first embodiment.

Referring to FIG. 6, the search circuit according to first embodiment includes a processor 501 and memory 506.

The processor 501 includes a plurality of first processing units 502-1 to 502-(K-8), a plurality of built-in memories 503-1 to 503-(K-8), a second processing unit 504, and an interface circuit 505 for exchanging data between the second processing unit 504 and the memory 506.

The plurality of first processing units 502-1 to 502-(K-8) (collectively referred to as the first processing unit 502) and the plurality of built-in memories 503-1 to 503-(K-8) (collectively referred to as the built-in memory 503) are associated with each other, and constitute a pipeline.

Specifically, in response to the input of the search key KEY, the first processing unit 502-1 accesses the built-in memory 503-1 to determine whether or not the search key KEY matches the data stored in the built-in memory 503-1. When it is determined that the search key KEY matches the data, the first processing unit 502-1 determines as match (Hit). On the other hand, the first processing unit 502-1 determines that mismatch (Miss) is made when it is determined that the search key KEY and the data do not coincide. Then, the determination result is output to the first processing unit 502-2 of the next stage together with the search key KEY.

The processing is sequentially repeated from the first processing unit 502-2 to the first processing unit 502-(K-8).

Then, the determination result of the first processing unit 502-(K-8) is output to the second processing unit 504. The second processing unit 504 accesses the memory 506 via the interface circuit 505 based on the determination result of the first processing unit 502-(K-8).

The memory 506 includes a plurality of memory banks. For example, eight memory banks are provided.

A method of allocating entry data according to first embodiment will be described. First embodiment allocates K memory accesses to perform a binary search in the manner shown in the following table.

TABLE 3

| | | | | | | | | |
|---|---|---|---|---|---|---|---|---|
| Number | 1 | 2 | 3 | K-8 | K-7 | K-6 | K-1 | K |
| of Search | | | | | | | | |
| times | | | | | | | | |
| Number | 1 | 2 | 4 | N/512 | N/256 | N/128 | N/4 | N/2 |
| of data | | | | | | | | |
| memory | 503 | 503 | 503 | 503 | 506 | 506 | 506 | 506 |
| instance | [1] | [2] | [3] | [K-8] | Bank0 | Bank1 | Bank6 | Bank7 |

In this embodiment, entry data of the last eight memory access stages (search stages) STAGE[K-7] to STAGE[K] which are the same as the number of memory banks in the memory 506 are allocated to the respective memory banks in the memory 506. In addition, the entry data of the remaining memory accessing stages (search stages) STAGE[1] to STAGE[K-8] are allocated to the built-in memories 503-1 to 503-[K-8] of the processor 501, respectively.

In this configuration, since the search stages STAGE[1] to STAGE[K-8] of the binary search executed by the processor 501 are pipelined, the binary search can be sequentially executed with a short latency and a throughput of one cycle.

The sum of the K-8 built-in memories 503 installed in the processor 501 is N/256.

Therefore, entry data having a total capacity of 1M addresses can be implemented in the processor 501 only by implementing a built-in memory of 4K address which is 1/256 of the entry data. It is possible to design the capacity of the built-in memory to be small.

The memory 506 is accessed for eight memory accesses after the search stage STAGE[K−7].

In this instance, entry data for each search stages is allocated to each memory bank.

Therefore, accesses to the same memory bank are not concentrated, and the memory banks BANK[0] to BANK[7] are sequentially accessed.

Therefore, the deterioration of the search performance due to the waiting time tRC due to the restriction of accesses to the same memory bank can be suppressed. The worst case search performance is defined by the number of memory accesses per binary search of 8.

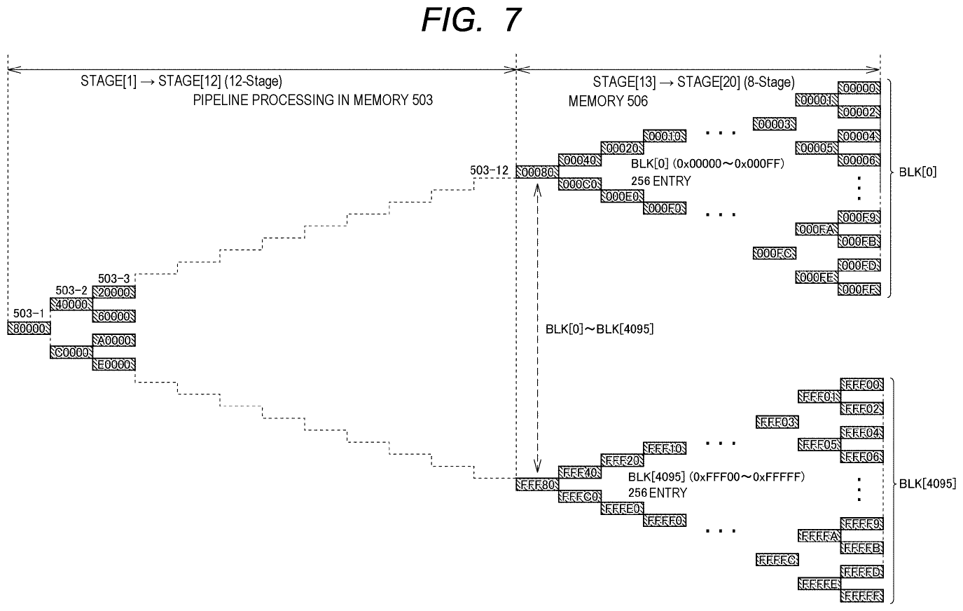

FIG. 7 is a diagram illustrating entry data of 1M addresses according to first embodiment.

As shown in FIG. 7, when the binary search is performed on the entry data of 1M addresses, 20 memory accesses are required. That is, Stage number of search stages is K=20.

Here, entry data of 1M addresses divided into search stages STAGE[1] to STAGE[20] are shown. As an example, a hexadecimal 20-bit memory address is shown.

In this embodiment, the entry data of 1M addresses are divided into two groups.

The entry data are divided into a first group of entry data stored in the plurality of built-in memories 503 and a second group of entry data stored in the memory 506.

The first group of entry data is stored in the built-in memory 503. Specifically, the entry data of the memory addresses corresponding to the search stages are sequentially stored in the built-in memory 503.

Specifically, the entry data of the memory address [80000] corresponding to the search stage STAGE[1] is stored in the built-in memory 503-1. Also, the entry data of the memory addresses [40000] and [00000] corresponding to the search stages STAGE[2] is stored in the built-in memory 503-2. Also, the entry data of the memory addresses [20000], [60000], [A0000], and [E0000] corresponding to the search stage STAGE[3] is stored in the built-in memory 503-3. Similarly, the entry data of the memory address corresponding to each search stage is sequentially stored in the built-in memory 503.

Next, the second group of entry data remaining other than the first group is stored in the memory 506. The memory 506 has eight memory banks.

In this embodiment, the remaining entry data is divided into a plurality of sub-entry data groups according to the eight search stages corresponding to the eight memory banks. In this example, the data are divided into a plurality of sub-entry data groups BLK[0] to BLK[4095]. One sub-entry data group BLK is composed of 256 pieces of entry data. The sub-entry data group BLK[0] is composed of entry data corresponding to memory addresses [00000] to [000FF], respectively. The sub-entry data group BLK[4095] is composed of entry data corresponding to memory addresses [FFF00]-[FFFFF].

The entry data of each sub-entry data group BLK are sequentially stored in memory banks BANK[0] to BANK[7] corresponding to search stages STAGE[13] to STAGE[20], respectively.

For example, for the sub-entry data group BLK[0], the entry data of the memory address [00080] corresponding to the search stage STAGE[13] is stored in the memory bank BANK[0]. The entry data of memory addresses [00040], [00000] corresponding to the search stage STAGE[14] are stored in the memory banks BANK[1]. Similarly, entry data of memory addresses corresponding to the respective search stages Stage are sequentially stored in the corresponding memory banks.

The same applies to the other sub-entry data groups BLK. According to this method, the entry data of the memory addresses corresponding to the search stage STAGE[13] of the sub-entry data groups BLK are stored in the memory bank BANK[0]. The entry data of the memory addresses corresponding to the search stage STAGE[14] of the sub-entry data groups BLK are stored in the memory bank BANK[1]. The entry data of the memory addresses corresponding to the search stage STAGE[15] of the sub-entry data groups BLK are stored in the memory bank BANK[2]. The entry data of the memory addresses corresponding to the search stage STAGE[16] of the sub-entry data groups BLK are stored in the memory bank BANK[3]. The entry data of the memory addresses corresponding to the search stage STAGE[17] of the sub-entry data groups BLK are stored in the memory bank BANK[4]. The entry data of the memory addresses corresponding to the search stage STAGE[18] of the sub-entry data groups BLK are stored in the memory bank BANK[5]. The entry data of the memory addresses corresponding to the search stage STAGE[19] of the sub-entry data groups BLK are stored in the memory bank BANK[6]. The entry data of the memory addresses corresponding to the search stage STAGE[20] of the sub-entry data groups BLK are stored in the memory bank BANK[7].

According to this method, by storing the entry data in the memory, the concentration of accesses to the same memory bank can be avoided. That is, the memory banks BANK[0] to BANK[7] are sequentially accessed after the search stages STAGE[13].

Therefore, the deterioration of the search performance due to the waiting time tRC based on the restriction of accesses to the same memory bank can be suppressed.

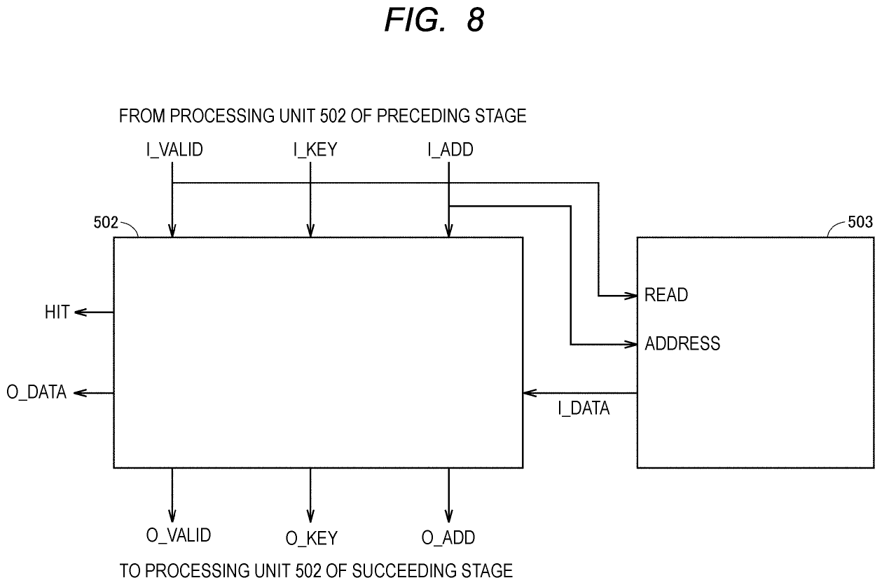

FIG. 8 is a diagram for explaining the operations of the first processing unit 502 and the built-in memory 503 according to first embodiment.

Referring to FIG. 8, a plurality of first processing units 502 execute a search operation of a first group of entry data in cooperation with a built-in memory 503.

Here, operations of the first processing unit 502 and the built-in memory 503 corresponding to a certain STAGE of search stages will be described.

The first processing unit 502 executes a search operation in accordance with the control signal I_VALID. Specifically, the first processing unit 502 executes a search operation to determine whether or not the search key I_KEY matches the entry data stored in the built-in memory 503 in accordance with the control signal I_VALID=“1”.

The control signals I_VALID are inputted as read commands READ to the built-in memories 503.

The built-in memory 503 executes a read operation in accordance with the input of the read command READ=“1” and the input of the search address I_ADD input as the address signal ADDRESS. Then, the built-in memory 503 outputs the entry data I_DATA stored at the specified address to the first processing unit 502.

The first processing unit 502 determines whether or not the entry data I_DATA matches the search key I_KEY, and when it is determined that the entry data I_DATA matches the search key I_KEY, outputs a match result (HIT “1”) and output data O_DATA included in the entry data I_DATA.

Here, the output data O_DATA is data output from the first processing unit 502 when the search key matches the entry data, and is set for each entry data stored in the search table. On the other hand, the first processing unit 502 determines whether or not the entry data I_DATA matches the search key I_KEY, and outputs a mismatch result (HIT “0”) when it is determined that the entry data I_DATA does not match the search key I_KEY. In this case, the first processing unit 502 does not output the output data O_DATA.

Then, the first processing unit 502 outputs the control signal O_VALID=“1”, the search key O_KEY, and the search address O_ADD to the next-stage first processing unit 502.

As described above, the first processing unit 502 of the next stage receives the input of the control signal I_VALID, the search key I_KEY, and the search address I_ADD, and repeats the same processing as described above.

In the above-described examples, the above-described processing is executed between the first processing units 502-1 to 502-12 and the built-in memories 503-1 to 503-12 corresponding to the search stages STAGE[1] to STAGE[12], respectively.

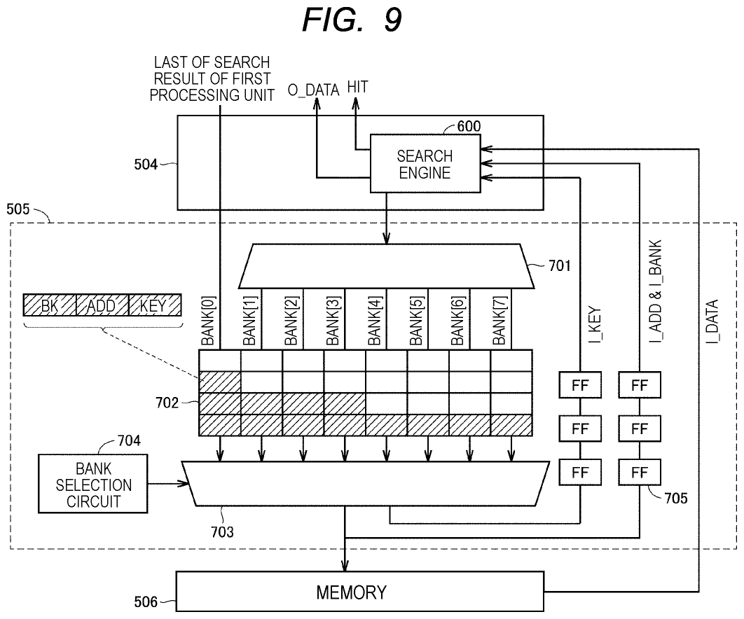

FIG. 9 is a diagram for explaining the operations of the second processing unit 504, the interface circuit 505, and the memory 506 according to first embodiment.

Referring to FIG. 9, the second processing unit 504 executes a search operation of the entry data of the second group in cooperation with the memory 506.

The second processing unit 504 includes a search engine 600 that continuously executes a search operation on the entry data group of the second group.

The interfacing circuit 505 includes a plurality of FIFO buffers 702, selection circuits 701 and 703, a bank selection circuit 704, and a plurality of flip-flops FF 705.

The second processing unit 504 receives the search result of the final first processing unit 502 and outputs the search result to FIFO buffers 702.

Each of the plurality of FIFO buffers 702 has a plurality of storage areas. A plurality of FIFO buffers 702 are provided corresponding to the plurality of memory banks, respectively. Specifically, as examples, a plurality of FIFO buffers 702 are provided corresponding to the memory banks BANK[0] to BANK[7], respectively.

As examples, four storage areas are provided in FIFO buffers 702 provided corresponding to one memory bank.

Each storage area can store a search key KEY, a search address ADD, and a bank address BK to be specified. FIFO buffers 702 are outputted in accordance with the order in which the data is inputted.

The first search key are stored in FIFO buffers 702 corresponding to the memory bank BANK[0].

The plurality of FIFO buffers 702 respectively outputs data to the selection circuit 703. The bank selection circuit 704 outputs signal for selecting data from the plurality of FIFO buffers 702 that are output to the selection circuit 703.

The selection circuit 703 outputs one of the data from the plurality of FIFO buffers 702 to the memory 506 in accordance with the selection signals from the bank selection circuit 704. The memory 506 is supplied with a search address ADD and a bank address BK to be specified among the data stored in FIFO buffer 702. The memory 506 outputs the entry data stored in the address specified based on the search address ADD and the specified bank address BK to the second processing unit 504.

The data output from the selection circuit 703 is stored in a plurality of flip-flops (FF) 705.

More specifically, the plurality of flip-flops (FF) 705 respectively store a search key KEY, a search address ADD, and a bank address BK to be specified.

In this example, a three-stage flip-flops (FF) 705 is provided. The three-stage flip-flops (FF) 705 are provided based on a latency until data is read by accessing the memory 506.

This is for accessing the memory 506 and adjusting the timing so that the data used in accessing is input to the search engine 600 at the same timing as the timing at which the entry data I_DATA based on the access is input to the search engine 600.

The number of stages of the flip-flops (FF) 705 can be adjusted to an arbitrary number. The search engine 600 performs a search operation to determine whether the entry data stored in the memory 506 matches the search key KEY.

The search engine 600 determines whether or not the entry data I_DATA matches the search key KEY, and outputs a match result (HIT “1”) and output data O_DATA included in the entry data I_DATA when it is determined that the entry data I_DATA matches the search key KEY.

On the other hand, the search engine 600 determines whether or not the entry data I_DATA matches the search key KEY, and when it is determined that the entry data I_DATA does not match the search key KEY, the search engine 600 does not output the output data O_DATA.

Then, the search engine 600 outputs the search key KEY, the search address ADD, and the bank address BK to be specified to the selection circuit 701 in order to execute the search operation again.

The selection circuit 701 selects one of the plurality of FIFO buffers 702. Specifically, the selection circuit 701 selects one FIFO buffer 702 corresponding to the next memory bank according to the bank address BK. For example, when the memory bank BANK[0] is specified in the previous search operation, the selection circuit 701 selects the FIFO buffers 702 corresponding to the memory bank BANK[1] to store the search key KEY, the search address ADD, and the specified bank address BK. When the search key KEY does not coincide with the entry data I_DATA, the process is repeated until the entry data I_DATA is stored in FIFO buffers 702 corresponding to the memory bank BANK[7].

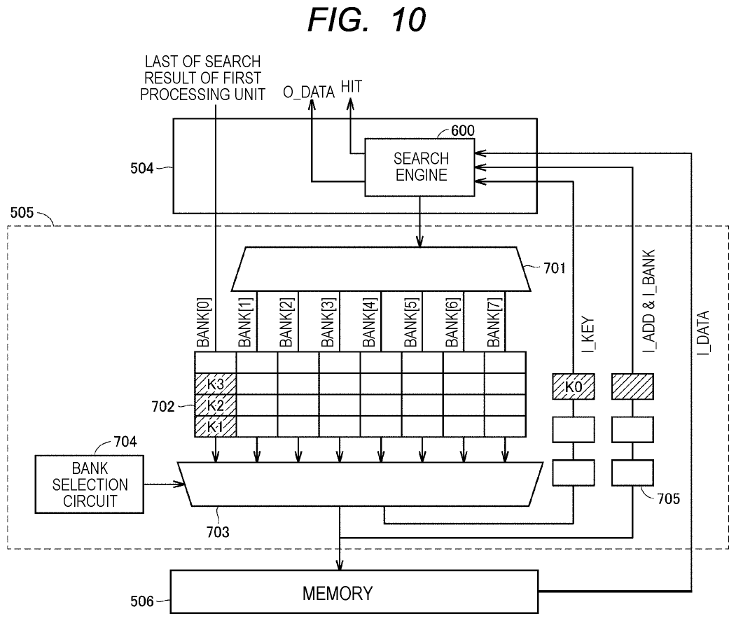

FIG. 10 is a diagram for explaining a search operation of a plurality of search keys K0 to K3 according to first embodiment.

Referring to FIG. 10, in this example, a case is shown in which search keys K0 to K3 are continuously input to execute a search operation.

The search keys K0 to K3 are sequentially stored in FIFO buffers 702 corresponding to the memory bank BANK[0].

Next, the selection circuit 703 outputs one of the data from the plurality of FIFO buffers 702 to the memory 506 in accordance with the selection signals from the bank selection circuit 704.

In this embodiment, data stored in FIFO buffers 702 corresponding to the memory banks BANK[0] are outputted. The selection circuit 703 outputs the address data input together with the search key K0 and the search key K0 to the memory 506.

Address data input together with the search key K0 and the search key K0 are stored in the flip-flops (FF) 705.

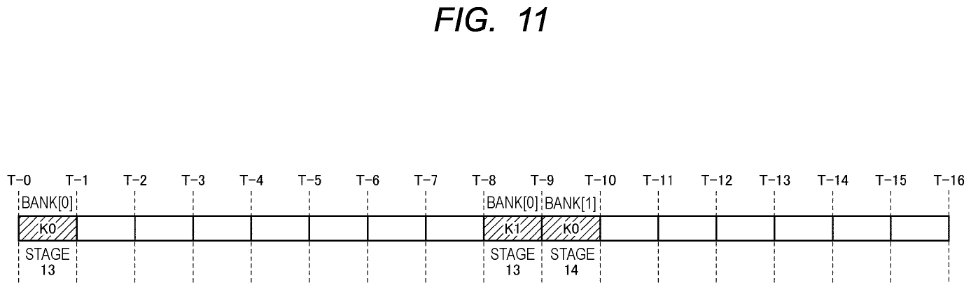

FIG. 11 is a diagram (part 1) illustrating a timing chart of a search operation of a plurality of search keys according to first embodiment.

Referring to FIG. 11, in cycle T-0, search key K0 is outputted from FIFO buffers 702 corresponding to memory bank BANK[0]. As a result, the search operation for the memory bank BANK[0] of the search stage STAGE[13] is executed for the search key K0.

In the subsequent cycles T-1 to T-7, since no data is stored in FIFO buffers 702 corresponding to the memory banks BANK[1] to [7], the data is not searched by the memory 506.

Next, in the cycle T-8, the search key K1 is outputted from FIFO buffers 702 corresponding to the memory bank BANK[0]. As a result, the search operation for the memory bank BANK[0] of the search stage STAGE[13] is executed for the search key K1.

In the following cycle T-9, the search key K0 is outputted from FIFO buffers 702 corresponding to the memory bank BANK[1]. As a result, the search operation for the memory bank BANK[1] of the search stage STAGE[14] is executed for the search key K0.

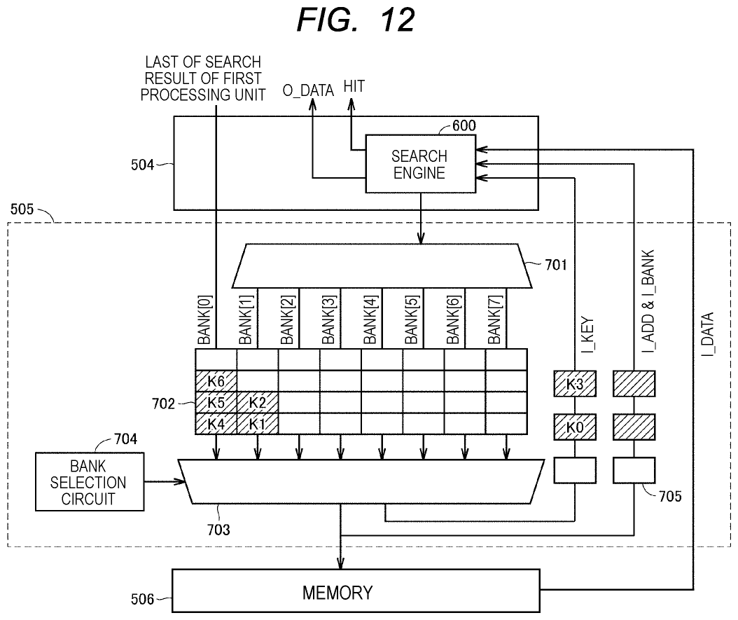

FIG. 12 is a diagram for explaining a search operation of a plurality of search keys K0 to K6 according to first embodiment.

Referring to FIG. 12, in this example, a case is shown in which search keys K0 to K6 are continuously input to execute a search operation.

As described above, the search keys K0 to K6 are sequentially stored in FIFO buffers 702 corresponding to the memory banks BANK[0]. Then, the search key is outputted from FIFO buffers 702 corresponding to the memory bank BANK[0]. As a result, the search operation for the memory bank BANK[0] of the search stage STAGE[13] is executed for the search key.

In this embodiment, the search keys K4, K5, and K6 are stored in FIFO buffer 702 corresponding to the memory bank BANK[0].

In addition, the search keys K1 and K2 are stored in FIFO buffer 702 corresponding to the memory bank BANK[1].

Then, the address data input together with the search keys K3 and K0 and the search keys K3 and K0 are stored in the flip-flops (FF) 705.

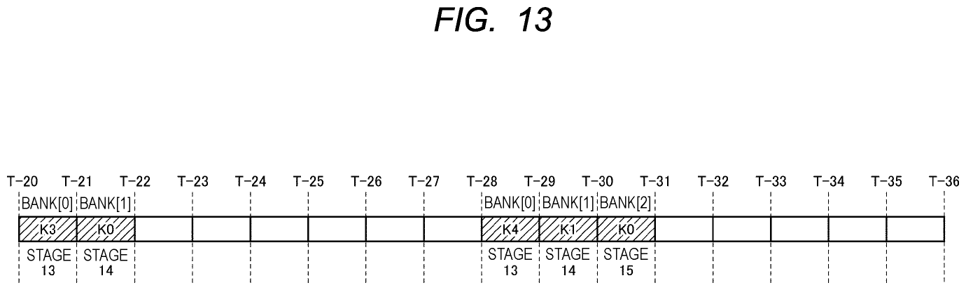

FIG. 13 is a diagram (part 2) illustrating a timing chart of a search operation of a plurality of search keys according to first embodiment.

Referring to FIG. 13, in T-20 of cycles, search key K3 is outputted from FIFO buffer 702 corresponding to memory bank BANK[0]. As a result, the search operation for the memory bank BANK[0] of the search stage STAGE[13] is executed for the search key K3.

In T-21 of cycles, the search key K0 is outputted from FIFO buffer 702 corresponding to the memory bank BANK[1]. As a result, the search operation for the memory bank BANK[1] of the search stage STAGE[14] is executed for the search key K0.

In the next-cycles T-22 to T-27, since the data are not stored in FIFO buffers 702 corresponding to the memory banks BANK[2] to [7], the search operation by the memory 506 is not executed.

Next, in the cyclic T-28, the search key K4 is outputted from FIFO buffer 702 corresponding to the memory bank BANK[0]. As a result, the search operation for the memory bank BANK[0] of the search stage STAGE[13] is executed for the search key K4.

In the next-cycle T-29, the search key K1 is outputted from FIFO buffer 702 corresponding to the memory bank BANK[1]. As a result, the search operation for the memory bank BANK[1] of the search stage STAGE[14] is executed for the search key K1.

In the next-cycle T-30, the search keys K0 is outputted from FIFO buffer 702 corresponding to the memory bank BANK[2]. As a result, the search operation for the memory bank BANK[2] of the search stage STAGE[15] is executed for the search key K0.

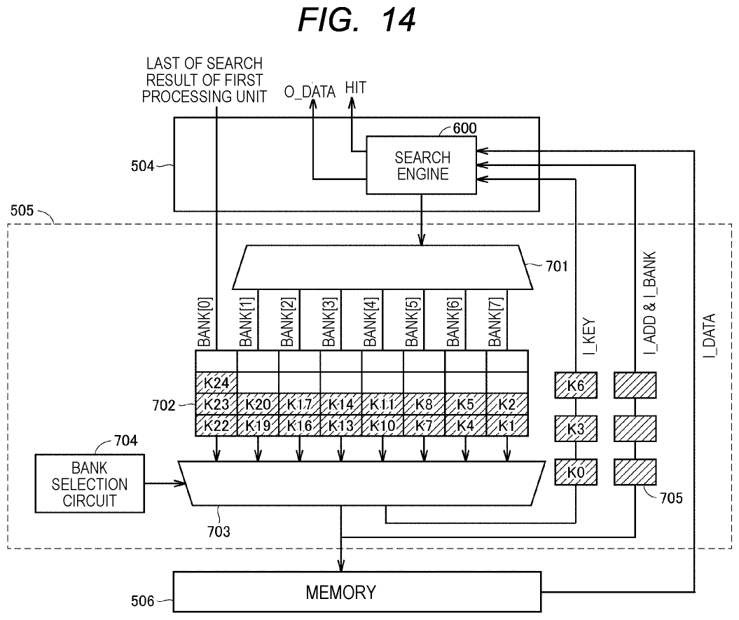

FIG. 14 is a diagram for explaining a search operation of a plurality of search keys K0 to K24 according to first embodiment.

Referring to FIG. 14, in this example, a case is shown in which search keys K0 to K24 are continuously input to execute a search operation.

As described above, the search keys K0 to K24 are sequentially stored in FIFO buffers 702 corresponding to the memory bank BANK[0]. Then, the search keys are outputted from FIFO buffer 702 corresponding to the memory bank BANK[0]. As a result, the search operation for the memory bank BANK[0] of the search stage STAGE[13] is executed for the search key.

In this embodiment, the search keys K22, K23, and K24 are stored in FIFO buffer 702 corresponding to the memory bank BANK[0].

In addition, the search keys K19 and K20 are stored in FIFO buffers 702 corresponding to the memory bank BANK[1].

In addition, the search keys K16 and K17 are stored in FIFO buffer 702 corresponding to the memory bank BANK[2].

In addition, the search keys K13 and K14 are stored in FIFO buffer 702 corresponding to the memory bank BANK[3].

In addition, the search keys K10 and K11 are stored in FIFO buffer 702 corresponding to the memory bank BANK[4].

In addition, the search keys K7 and K8 are stored in FIFO buffers 702 corresponding to the memory bank BANK[5].

In addition, the search keys K14 and K5 are stored in FIFO buffer 702 corresponding to the memory bank BANK[6].

In addition, the search keys K11 and K2 are stored in FIFO buffer 702 corresponding to the memory bank BANK[7].

Address data input together with the search keys K6, K3, and K0 and the search keys K6, K3, and K0 are stored in the flip-flops (FF) 705.

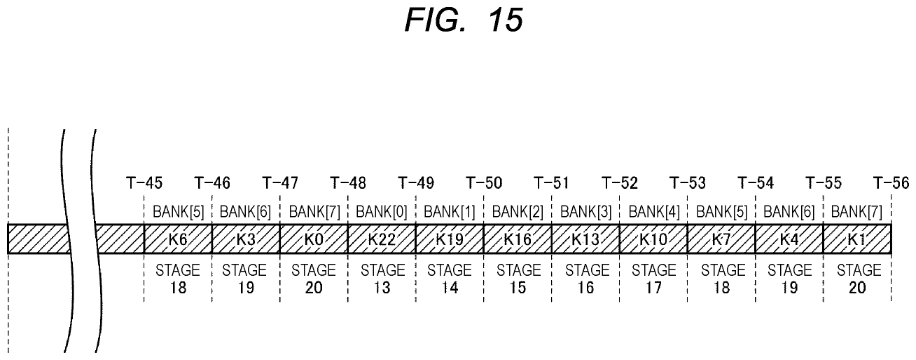

FIG. 15 is a diagram (part 3) illustrating a timing chart of a search operation of a plurality of search keys according to first embodiment.

Referring to FIG. 15, in T-45 of cycles, search key K6 is outputted from FIFO buffer 702 corresponding to memory bank BANK[5]. As a result, the search operation for the memory bank BANK[5] of the search stage STAGE[18] is executed for the search key K6.

In T-46 of cycles, the search key K3 is outputted from FIFO buffer 702 corresponding to the memory bank BANK[6]. As a result, the search operation for the memory bank BANK[6] of the search stage STAGE[19] is executed for the search key K3.

In T-47 of cycles, the search key K0 is outputted from FIFO buffer 702 corresponding to the memory bank BANK[7]. As a result, the search operation for the memory bank BANK[7] of the search stage STAGE[20] is executed for the search key K0.

In T-48 of cycles, the search key K22 is outputted from FIFO buffers 702 corresponding to the memory bank BANK[0]. As a result, the search operation for the memory bank BANK[0] of the search stage STAGE[13] is executed for the search key K22.

In T-49 of cycles, the search key K19 is outputted from FIFO buffer 702 corresponding to the memory bank BANK[1]. As a result, the search operation for the memory bank BANK[1] of the search stage STAGE[14] is executed with respect to the search key K19.

In T-50 of cycles, the search key K16 is outputted from FIFO buffer 702 corresponding to the memory bank BANK[2]. As a result, the search operation for the memory bank BANK[2] of the search stage STAGE[15] is executed for the search key K16.

In T-51 of cycles, the search key K13 is outputted from FIFO buffer 702 corresponding to the memory bank BANK[3]. As a result, the search operation for the memory bank BANK[3] of the search stage STAGE[16] is executed for the search key K13.

In T-52 of cycles, the search key K10 is outputted from FIFO buffer 702 corresponding to the memory bank BANK[4]. As a result, the search operation for the memory bank BANK[4] of the search stage STAGE[17] is executed for the search key K10.

In T-53 of cycles, the search key K7 is outputted from FIFO buffer 702 corresponding to the memory bank BANK[5]. As a result, the search operation for the memory bank BANK[5] of the search stage STAGE[18] is executed for the search key K7.

In T-54 of cycles, the search key K4 is outputted from FIFO buffer 702 corresponding to the memory bank BANK[6]. As a result, the search operation for the memory bank BANK[6] of the search stage STAGE[19] is executed for the search key K4.

In T-55 of cycles, the search key K1 is outputted from FIFO buffers 702 corresponding to the memory bank BANK[7]. As a result, the search operation for the memory bank BANK[7] of the search stage STAGE[20] is executed for the search key K1.

As shown in this method, by sequentially accessing the memory banks BANK[0] to BANK[7] during a search operation, NOP (No Operation) cycles can be suppressed, and an efficient search operation can be performed during a search operation of a plurality of search keys.

### Second Embodiment

In the above first embodiment, the entry data are divided into two groups, and the entry data of the first group stored in the plurality of built-in memories 503 and the entry data of the second group stored in the memory 506 are divided. The entry data remaining other than the first group are divided into a plurality of sub-entry data groups grouped according to Stage of eight search stages corresponding to the number of memory banks. The entry data of each sub-entry data group BLK is sequentially stored in the memory banks Bank corresponding to each of the search stages.

In this instance, as shown in FIG. 6, the capacity used by the memory bank corresponding to the preceding search stage is ½ of the capacity used by the memory bank corresponding to the subsequent search stage. Therefore, when a plurality of memory banks are all designed with the same capacity, a larger unused capacity exists as the memory bank corresponding to the preceding search stage becomes.

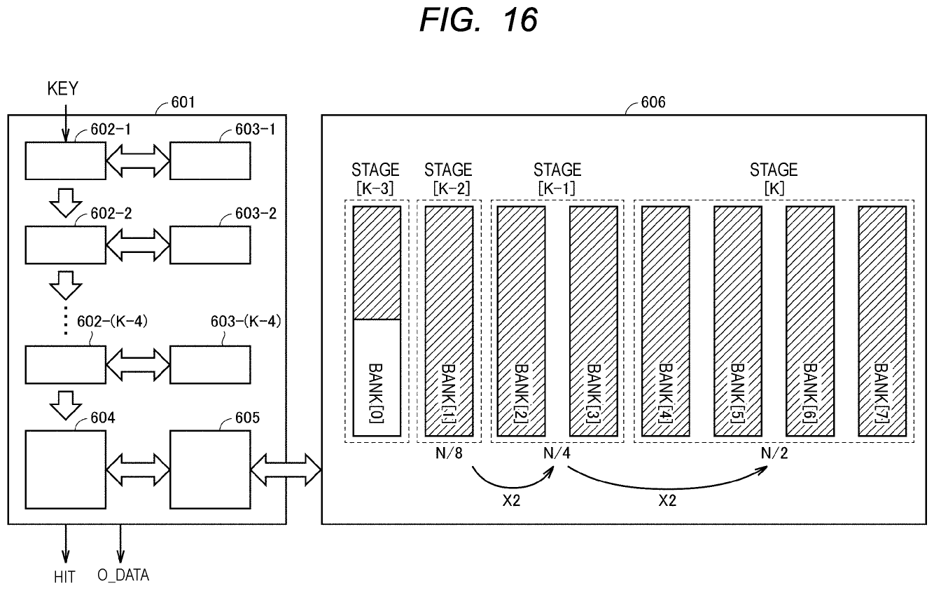

In second embodiment, a method of efficiently using the capacities of memories will be described. FIG. 16 is a diagram for explaining an outline of search algorithms for binary search according to second embodiment.

Referring to FIG. 16, the search circuit according to second embodiment includes a processor 601 and memory 606.

The processor 601 includes a plurality of first processing units 602-1 to 602-(K−4), a plurality of built-in memories 603-1 to 603-(K−4), a second processing unit 604, and an interface circuit 605 for exchanging data between the second processing unit 604 and the memory 606.

The plurality of first processing units 602-1 to 602-(K−4) and the plurality of built-in memories 603-1 to 603-(K−4) are associated with each other, and constitute pipeline.

Specifically, in response to the input of the search key KEY, the first processing unit 602 accesses the built-in memory 603 to determine whether or not the search key KEY matches the data stored in the built-in memory 603. When it is determined that the search key KEY matches with the data, the first processing unit 602 determines as match (HIT). Then, information associated with the data is output. On the other hand, when it is determined that the search key KEY and the data do not match, the first processing unit 602 determines as mismatch (Miss). Then, it outputs the search key KEY together with the determination result to the first processing unit 602 of the next stage.

The processing is sequentially repeated. Then, the determination result of the first processing unit 602-(K−4) is output to the second processing unit 604.

The second processing unit 604 accesses the memory 606 via the interface circuit 605 based on the determination result of the first processing unit 602-(K−4).

The memory 606 includes a plurality of memory banks. For example, eight memory banks are provided.

In this embodiment, entry data of the number of memory accessing stages (search stages) STAGE[K−3] to STAGE[K], which differ from the number of memory banks included in the memory 606, are allocated to the respective memory banks of the memory 506.

Entry data of the remaining number of memory accessing stages (search stages) STAGE[1] to STAGE[K−4] are allocated to the built-in memories 603-1 to 603-[K−4] of the processor 601, respectively.

In this configuration, since the search stages STAGE[1] to STAGE[K−4] of the binary search executed by the processor 601 are pipelined, the binary search can be sequentially executed with a short latency and a throughput of one cycle.

Four memory accesses after the search stage STAGE[K−3] access the memory 606.

Specifically, the number of search stages to be executed in the memory 606 is set to Log₂(the number of memory banks M)+1.

In this embodiment, entry data corresponding to 4 stages of the search stages are stored in the memory 606.

Specifically, the entry data corresponding to the search stage STAGE[K−3] is stored in the memory bank BANK[0]. Next, the entry data corresponding to the search stage STAGE[K−2] is stored in the memory bank BANK[1]. Next, the entry data corresponding to the search stage STAGE[K−1] is stored in the memory banks BANK[2] and BANK[3]. Next, the entry data corresponding to the search stages STAGE[K] is stored in the memory banks BANK[4], BANK[5], BANK[6], and BANK[7].

Since the search operation is basically the same as that described in the above first embodiment, detailed descriptions thereof will not be repeated.

In second embodiment, the storage capacity of the memory 606 can be effectively utilized efficiently.

### Third Embodiment

In third embodiment, a method of more efficiently using the capacities of memories will be described.

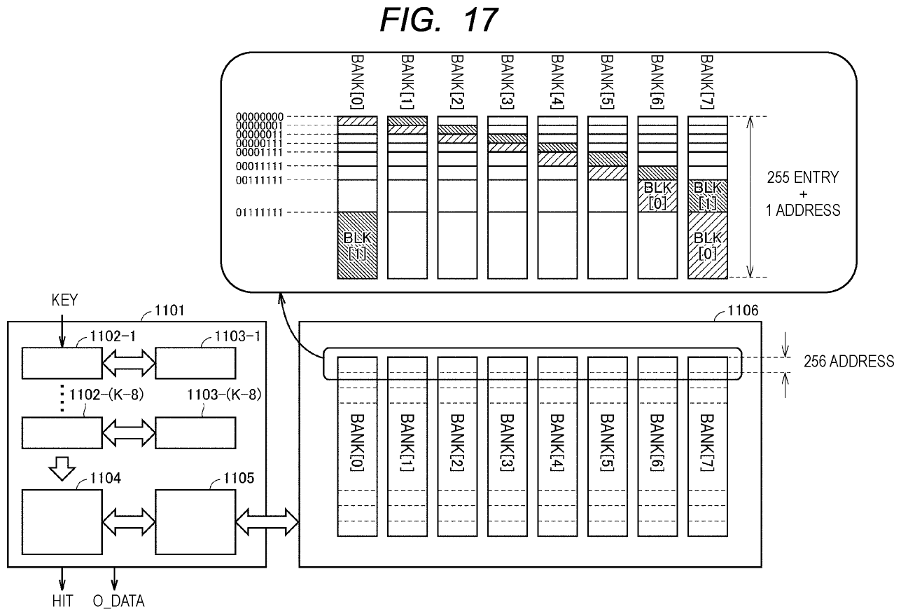

FIG. 17 is a diagram for explaining an outline of search algorithms for binary searches according to third embodiment.

Referring to FIG. 17, the search circuit according to third embodiment includes a processor 1101 and a memory 1106.

The processor 1101 includes a plurality of first processing units 1102-1 to 1102-(K−8), a plurality of built-in memories 1103-1 to 1103-(K−8), a second processing unit 1104, and an interface circuit 1105 for exchanging data between the second processing unit 1104 and the memory 1106. The plurality of first processing units 1102-1 to 1102-(K−8) have the same functions as the plurality of first processing units 502-1 to 502-(K−8) of first embodiment, and their descriptions are omitted.

Then, the determination result of the first processing unit 1102-(K−8) is output to the second processing unit 1104.

The second processing unit 1104 accesses the memory 1106 via the interface circuit 1105 based on the determination result of the first processing unit 1102-(K−8).

The memory 1106 includes a plurality of memory banks. For example, eight memory banks are provided.

In this embodiment, entry data of the same number of memory accessing stages (search stages) STAGE[K−7] to STAGE[K] as the number of memory banks included in the memory 1106 are allocated to the respective memory banks of the memory 1106.

In this configuration, since the search stages STAGE[1] to STAGE[K−8] of the binary search executed by the processor 1101 are pipelined, the binary search can be sequentially executed with a short latency and a throughput of one cycle.

Eight memory accesses after the search stage STAGE[K−7] access the memory 1106.

Referring to FIG. 17, in the present embodiment, the entry data of 1M addresses are divided into two groups.

The entry data are divided into entry data of first group stored in the plurality of built-in memories 1103 and entry data of a second group stored in the memory 1106.

The entry data of the first group are stored in the memory 1103. Next, the entry data of the second group other than the first group are stored in the memory 1106. The memory 1106 has eight memory banks.

In this embodiment, the remaining entry data are divided into a plurality of sub-entry data groups grouped according to the eight search stages corresponding to the eight memory banks. In this example, the data are divided into a plurality of sub-entry data groups BLK[0] to BLK[4095].

One sub-entry data group BLK is composed of 256 pieces of entry data. The entry data of each sub-entry data group BLK corresponds to each of the search stages STAGE[13] to STAGE[20], and the entry data corresponding to the search stages STAGE[13] to STAGE[20] are sequentially stored in the memory banks BANK[0] to BANK[7].

In this third embodiment, in the sub-entry data group BLK[0], entry data corresponding to the search stages STAGE[13] to STAGE[20] are sequentially stored in the memory banks BANK[0] to BANK[7]. In the sub-entry data group BLK[1], entry data corresponding to the search stages STAGE[13] to STAGE[20] are sequentially stored in the memory banks BANK[1] to BANK[7] and BANK[0]. In the sub-entry data group BLK[2], entry data corresponding to the search stages STAGE[13] to STAGE[20] are sequentially stored in the memory banks BANK[2] to BANK[7], BANK[0], and BANK[1].

The other sub-entry data groups BLKs are stored in the memory banks in the same manner. That is, the entry data of each sub-entry data group BLK is sequentially stored in one of the corresponding memory banks BANK[0] to BANK[7] for each of the search stages STAGE[13] to STAGE[20].

According to this method, it is possible to avoid concentration of entry data in the memory banks corresponding to the subsequent stage of the search stages, and it is possible to smoothen the used capacitances of the respective memory banks. Further, since the corresponding memory banks differs for each of the search stages STAGE[13] to STAGE[20] with respect to the entry data of each sub-entry data group BLK, it is also possible to suppress the deterioration of the search performance due to the waiting time tRC due to the limits on accesses to the same memory bank.

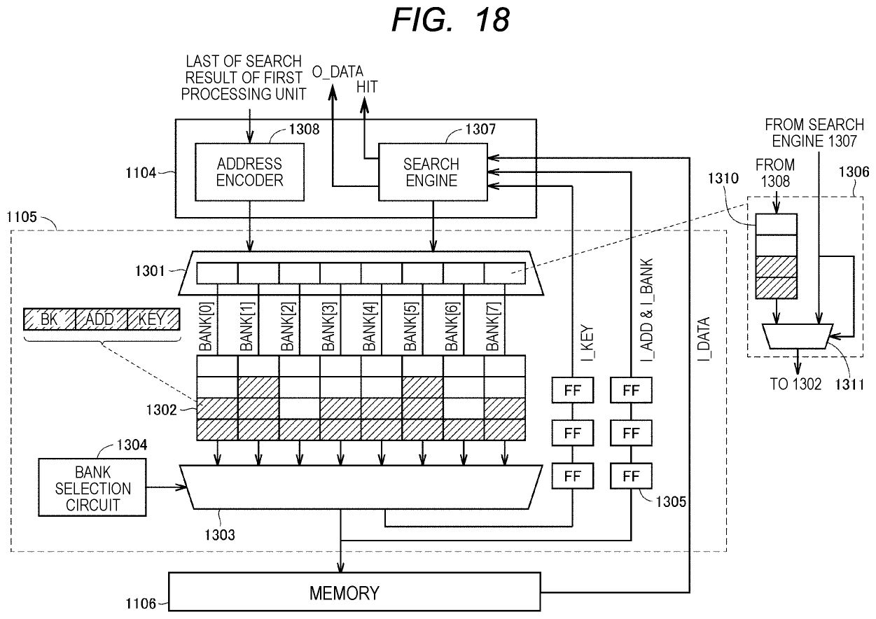

FIG. 18 is a diagram for explaining operations of the second processing unit 1104, the interface circuit 1105, and the memory 1106 according to third embodiment.

Referring to FIG. 18, the second processing unit 1104 performs a search operation for a second group of entry data in cooperation with the memory 1106.

The second processing unit 1104 includes a search engine 1307 for continuously performing a search operation on the entry data of the second group, and an address encoder 1308.

The interface circuit 1105 includes a plurality of FIFO buffers 1302, selection circuits 1301 and 1303, a bank selection circuit 1304, and a plurality of flip-flops (FF) 1305.

The address encoder 1308 receives the search result of the final first processing unit 1102, and converts the search result into an address specifying memory bank of the memory 1106 corresponding to the subsequent search stages STAGE[13]. For example, where based on the search result of the final first processing unit 1102, the block address of the sub-entry data group BLK to be accessed next is nBLK, the remaining search number executed in the memory 1106 is nStage, and the number of memory banks in the memory 1106 is nBank, then, the address encoder 1308 outputs (nBLK+nStage) % nBank as the address specifying the memory bank. Address encoder 1308 also generates a search address within the memory bank of memory 1106. The address encoder 1308 outputs the converted address and the search key KEY to the selection circuit 1301.

As described above, the memory banks corresponding to the search stages STAGE[13] to STAGE[20] differ for each sub-entry data group BLK.

For example, when the entry data corresponding to the search STAGE[13] of the sub-entry data group BLK[0] is searched, the search key KEY, the search address ADD, and the bank address BK to be specified are stored in FIFO buffer 1102 corresponding to the memory bank BANK[0].

When the entry data corresponding to the search STAGE[13] of the sub-entry data group BLK[1] is searched, the search key KEY, the search address ADD, and the bank address BK to be specified are stored in FIFO buffer 1102 corresponding to the memory bank BANK[1].

The same applies to the case of searching the entry data of the other sub-entry data group BLK.

The selection circuit 1301 includes a plurality of arbitration circuits 1306. The plurality of arbitration circuits 1306 correspond to the plurality of FIFO buffers 1302 provided corresponding to the memory banks BANK[0] to BANK[7], respectively.

The arbitration circuit 1306 includes FIFO buffer 1310 and selector 1311. The selector 1311 receives the output of FIFO buffer 1310 and the output result from the search engine 1307, and outputs one of them. In the present embodiment, the output result from the search engine 1307 is preferentially output.

When the output result from the search engine 1307 is received, the output result is output to the corresponding FIFO buffer 1302. On the other hand, when the output result from the search engine 1307 is not received, the information stored in FIFO buffer 1310 is output to FIFO buffer 1302.

Each of the plurality of FIFO buffers 1302 has a plurality of storage areas. The plurality of FIFO buffers 1302 are provided corresponding to the plurality of memory banks, respectively. Specifically, as examples, the plurality of FIFO buffers 1302 are provided corresponding to the memory banks BANK[0] to BANK[7].

As examples, four storage areas are provided in FIFO buffers 1302 provided corresponding to one memory bank.

Each storage area can store a search key KEY, a search address ADD, and a bank address BK to be specified. FIFO buffers 1302 are outputted in accordance with the order in which the data is inputted.

The plurality of FIFO buffers 1302 respectively outputs data to the selection circuit 1303. The bank selection circuit 1304 outputs signal for selecting the data from the plurality of FIFO buffers 1302 which are outputted to the selection circuit 1303.

The selection circuit 1303 outputs one of the data from the plurality of FIFO buffers 1302 to the memory 1106 according to the selection signals from the bank selection circuit 1304. The memory 1106 is supplied with the search address ADD and the bank address BK to be specified among the data stored in FIFO buffer 1302. The memory 1106 outputs the entry data stored in the address specified based on the search address ADD and the specified bank address BK to the second processing unit 1104. The data output from the selection circuit 1303 is stored in a plurality of flip-flops (FF) 1305.

More specifically, the plurality of flip-flops (FF) 1305 respectively store the search key KEY, the search address ADD, and a bank address BK to be specified.

In this example, a three-stage flip-flop (FF) 1305 is provided. The three-stage flip-flop (FF) 1305 is provided based on a latency until data is read by accessing the memory 1106.

This is for accessing the memory 1106 and adjusting the timing so that the data used in accessing is input to the search engine 1307 at the same timing as the timing at which the entry data I_DATA based on the access is input to the search engine 1307.

The number of stages of the flip-flop (FF) 1305 can be adjusted to an arbitrary number. The search engine 1307 performs a search operation to determine whether or not the entry data stored in the memory 1106 matches the search key KEY.

The search engine 1307 determines whether or not the entry data I_DATA matches the search key KEY, and outputs a match result (HIT “1”) and output data O_DATA included in the entry data I_DATA when it is determined that the entry data I_DATA matches with the search key KEY.

On the other hand, the search engine 1307 determines whether or not the entry data I_DATA matches the search key KEY, and when it is determined that the entry data I_DATA does not match, the search engine 1307 does not output the output data O_DATA.

Then, the search engine 1307 outputs the search key KEY, the search address ADD, and the bank address BK to be specified to the selection circuit 1301 in order to execute the search operation again.

The selection circuit 1301 outputs the search key KEY, the search address ADD, and the bank address BK to be specified to any one of the plurality of FIFO buffers 1302.

Specifically, the selection circuit 1301 outputs them to FIFO buffer 1302 corresponding to the next memory bank according to the bank address BK. For example, when the memory bank BANK[0] is specified in the previous search operation, the selection circuit 1301 outputs the search key KEY, the search address ADD, and the specified bank address BK to FIFO buffers 1302 corresponding to the memory bank BANK[1]. When the search key KEY does not coincide with the entry data I_DATA, the process is repeated until the search key KEY and the entry data I_DATA are stored in FIFO buffers 1302 corresponding to the last memory bank.

As described above, with respect to the entry data of each sub-entry data group BLK, corresponding memory banks differs for each of the search stages STAGE[13] to STAGE[20]. Therefore, according to this method, the search key KEY, the search address ADD, and the bank address BK to be specified are outputted and stored in any one of the plurality of FIFO buffers 1302. That is, in the above-described method of first embodiment, the search key KEY, the search address ADD, and the bank address BK to be specified were initially stored in FIFO buffer corresponding to the memory bank BANK[0] corresponding to the search stage STAGE[13]. On the other hand, in the method according to third embodiment, the search key KEY, the search address ADD, and the bank address BK to be specified are outputted to any one of the plurality of FIFO buffers 1302 and are stored in a distributed manner.

Therefore, different memory banks can be accessed for each search stage, and the number of entries allocated to each memory bank can be averaged, and as a result, the memory can be efficiently used.

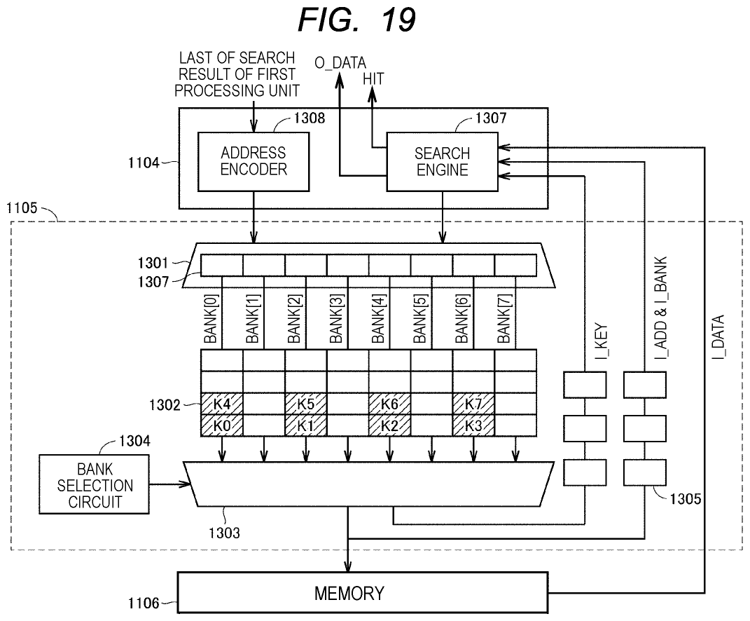

FIG. 19 is a diagram for explaining a search operation of a plurality of search keys K0 to K7 according to third embodiment.

Referring to FIG. 19, in this example, a case is shown in which search keys K0 to K7 are continuously input to execute a search operation. Here, a case will be described in which all the memory banks specified by the address encoder 1308 based on the search result of the search keys K0 to K7 by the processor 1101 are even-numbered banks. That is, it is assumed that the entry data corresponding to the search stage STAGE[13] is stored in the even-numbered banks.

That is, the search key K0 is stored in FIFO buffer 1302 corresponding to the memory bank BANK[0]. The search key K1 is stored in FIFO buffer 1302 corresponding to the memory bank BANK[2]. The search key K2 is stored in FIFO buffer 1302 corresponding to the memory bank BANK[4]. The search key K3 is stored in FIFO buffer 1302 corresponding to the memory bank BANK[6]. The search key K4 is stored in FIFO buffer 1302 corresponding to the memory bank BANK[0]. The search key K5 is stored in FIFO buffer 1302 corresponding to the memory bank BANK[2]. The search key K6 is stored in FIFO buffer 1302 corresponding to the memory bank BANK[4]. The search key K7 is stored in FIFO buffer 1302 corresponding to the memory bank BANK[6]. That is, the search keys K(4n+0) are first stored in FIFO buffer 1302 corresponding to the memory bank BANK[0]. The search keys K(4n+1) are initially stored in FIFO buffer 1302 corresponding to the memory bank BANK[2]. The search keys K(4n+2) are initially stored in FIFO buffer 1302 corresponding to the memory bank BANK[4]. The search keys K(4n+3) are initially stored in FIFO buffer 1302 corresponding to the memory bank BANK[6]. Next, the selection circuit 1303 outputs one of the data from the plurality of FIFO buffers 1302 to the memory 1106 according to the selection signals from the bank selection circuit 1304.

In this embodiment, data stored in FIFO buffer 1302 corresponding to the memory bank BANK[0] are outputted.

The selection circuit 1303 outputs the address data input together with the search key K0 and the search key K0 to the memory 1106.

The address data input together with the search key K0 and the search key K0 are stored in the flip-flop (FF) 1305.

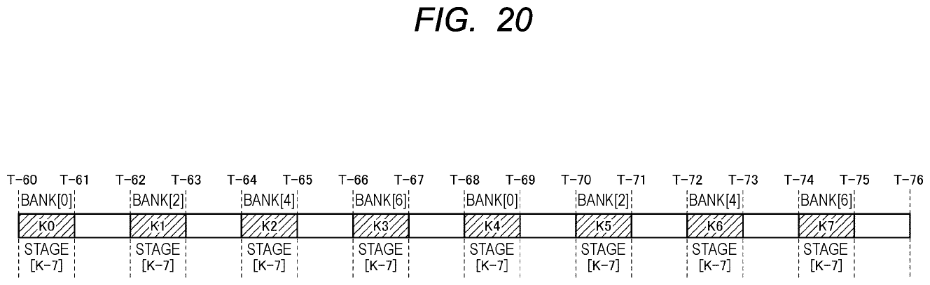

FIG. 20 is a diagram (part 1) for explaining a timing chart of a search operation of a plurality of search keys according to third embodiment.

Referring to FIG. 20, in T-60 of cycles, search key K0 is outputted from FIFO buffer 1302 corresponding to memory bank BANK[0]. As a result, the search operation for the memory bank BANK[0] of the search stage STAGE[13] is executed for the search key K0.

In the next-cycle T-61, since data is not stored in FIFO buffer 1302 corresponding to the memory bank BANK[1], the search operation by the memory 1106 is not executed.

In the next-cycle T-62, the search key K1 is outputted from FIFO buffer 1302 corresponding to the memory bank BANK[2]. As a result, the search operation for the memory bank BANK[2] of the search stage STAGE[13] is executed for the search key K1.

In the next-cycle T-63, since data is not stored in FIFO buffer 1302 corresponding to the memory bank BANK[3], the search operation by the memory 1106 is not executed.

In the next-cycle T-64, the search key K2 is outputted from FIFO buffer 1302 corresponding to the memory bank BANK[4]. As a result, the search operation for the memory bank BANK[4] of the search stage STAGE[13] is executed for the search key K2.

In the next-cycle T-65, since data is not stored in FIFO buffer 1302 corresponding to the memory bank BANK[5], the search operation by the memory 1106 is not executed.

In the next-cycle T-66, the search key K3 is outputted from FIFO buffer 1302 corresponding to the memory bank BANK[6]. As a result, the search operation for the memory bank BANK[6] of the search stage STAGE[13] is executed for the search key K3.

In the next-cycle T-67, since no data is stored in FIFO buffer 1302 corresponding to the memory bank BANK[7], the search operation by the memory 1106 is not executed.

In the next-cycle T-68, the search key K4 is outputted from FIFO buffer 1302 corresponding to the memory bank BANK[0]. As a result, the search operation for the memory bank BANK[0] of the search stage STAGE[13] is executed for the search key K4.

In the next-cycle T-69, since data is not stored in FIFO buffer 1302 corresponding to the memory bank BANK[1], the search operation by the memory 1106 is not executed.

In the next-cycle T-70, the search key K5 is outputted from FIFO buffer 1302 corresponding to the memory bank BANK[2]. As a result, the search operation for the memory bank BANK[2] of the search stage STAGE[13] is executed for the search key K5.

In the next-cycle T-71, since data is not stored in FIFO buffer 1302 corresponding to the memory bank BANK[3], the search operation by the memory 1106 is not executed.

In the next-cycle T-72, the search key K6 is outputted from FIFO buffer 1302 corresponding to the memory bank BANK[4]. As a result, the search operation for the memory bank BANK[4] of the search stage STAGE[13] is executed for the search key K6.

In the next-cycle T-73, since data is not stored in FIFO buffer 1302 corresponding to the memory bank BANK[5], the search operation by the memory 1106 is not executed.

In the next-cycle T-74, the search key K7 is outputted from FIFO buffer 1302 corresponding to the memory bank BANK[6]. As a result, the search operation for the memory bank BANK[2] of the search stage STAGE[13] is executed for the search key K7.

In the next-cycle T-75, since no data is stored in FIFO buffer 1302 corresponding to the memory bank BANK[7], the search operation by the memory 1106 is not executed.

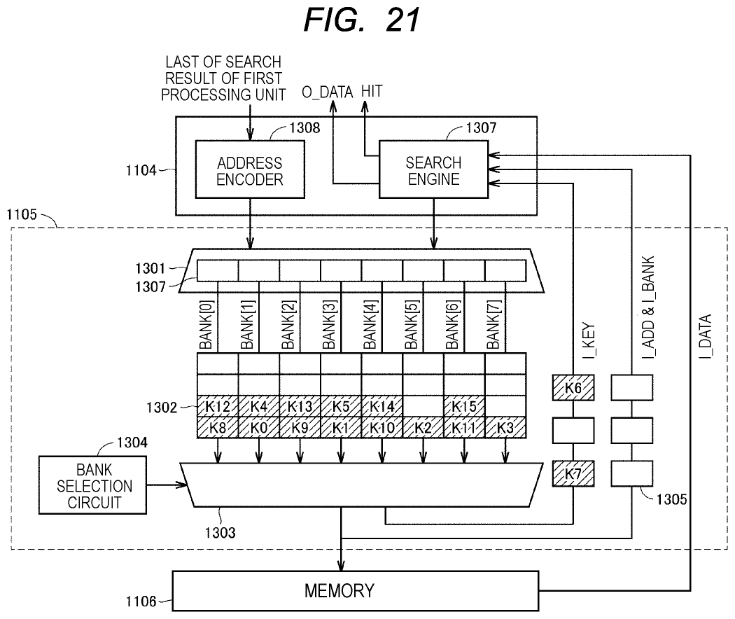

FIG. 21 is a diagram for explaining a search operation of a plurality of search keys K0 to K15 according to third embodiment.

Referring to FIG. 21, in this example, a case is shown in which search keys K0 to K15 are continuously input to execute a search operation. Here, a case will be described in which all the memory banks specified by the address encoder first are even-numbered banks based on the result of search of the search keys K0 to K15 by the processor 1101.

As described above, the search keys K0 to K7 are sequentially stored in FIFO buffers 1302 corresponding to the memory bank BANK[0], BANK[2], BANK[4], and BANK[6], respectively. For example, the search key is outputted from FIFO buffer 1302 corresponding to the memory bank BANK[0]. The search operation for the memory bank BANK[0] of the search stage STAGE[13] is executed for the search key.

When the search process of the search stage STAGE[13] is executed, in the next search stage STAGE[14], a bank next to the memory bank from which the search is started is specified. In FIG. 21, FIFO buffers 1302 corresponding to memory banks BANK[1], BANK[3], BANK[5], and BANK[7] are designated as search operations of search stage STAGE[14] in accordance with the search operations for search keys K0 to K5.

Further, a case is shown in which new search keys K8 to K15 are continuously input to execute a search operation.

The search key K8 is stored in FIFO buffer 1302 corresponding to the memory bank BANK[0]. The search key K9 is stored in FIFO buffer 1302 corresponding to the memory bank BANK[2]. The search key K10 is stored in FIFO buffer 1302 corresponding to the memory bank BANK[4]. The search key K11 is stored in FIFO buffer 1302 corresponding to the memory bank BANK[6]. The search key K12 is stored in FIFO buffer 1302 corresponding to the memory bank BANK[0]. The search key K13 is stored in FIFO buffer 1302 corresponding to the memory bank BANK[2]. The search key K14 is stored in FIFO buffer 1302 corresponding to the memory bank BANK[4]. The search key K15 is stored in FIFO buffer 1302 corresponding to the memory bank BANK[6].

Then, the address data input together with the search keys K6 and K7 and the search keys K6 and K7 are stored in the flip-flop (FF) 1305.

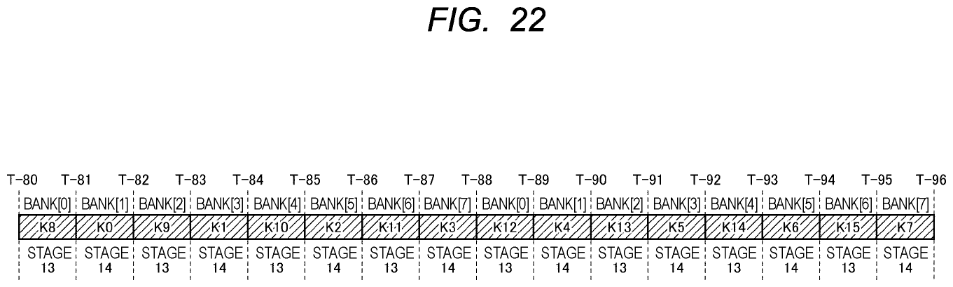

FIG. 22 is a diagram (part 2) illustrating a timing chart of a search operation of a plurality of search keys according to third embodiment.

Referring to FIG. 22, in T-80 of cycles, search key K8 is outputted from FIFO buffer 1302 corresponding to memory bank BANK[0]. As a result, the search operation for the memory bank BANK[0] of the search stage STAGE[13] is executed for the search key K8.

In T-81 of cycles, the search key K0 is outputted from FIFO buffer 1302 corresponding to the memory bank BANK[1]. As a result, the search operation for the memory bank BANK[1] of the search stage STAGE[14] is executed for the search key K0.

In T-82 of cycles, the search key K9 is outputted from FIFO buffer 1302 corresponding to the memory bank BANK[2]. As a result, the search operation for the memory bank BANK[2] of the search stage STAGE[13] is executed for the search key K9.

In T-83 of cycles, the search key K1 is outputted from FIFO buffer 1302 corresponding to the memory bank BANK[3]. As a result, the search operation for the memory bank BANK[3] of the search stage STAGE[14] is executed for the search key K1.

In T-84 of cycles, the search key K10 is outputted from FIFO buffer 1302 corresponding to the memory bank BANK[4]. As a result, the search operation for the memory bank BANK[4] of the search stage STAGE[13] is executed for the search key K10.

In T-85 of cycles, the search key K2 is outputted from FIFO buffer 1302 corresponding to the memory bank BANK[5]. As a result, the search operation for the memory bank BANK[5] of the search stage STAGE[14] is executed for the search key K2.

In T-86 of cycles, the search key K11 is outputted from FIFO buffer 1302 corresponding to the memory bank BANK[6]. As a result, the search operation for the memory bank BANK[6] of the search stage STAGE[13] is executed for the search key K11.

In T-87 of cycles, the search key K3 is outputted from FIFO buffer 1302 corresponding to the memory bank BANK[7]. As a result, the search operation for the memory bank BANK[7] of the search stage STAGE[14] is executed for the search key K3.

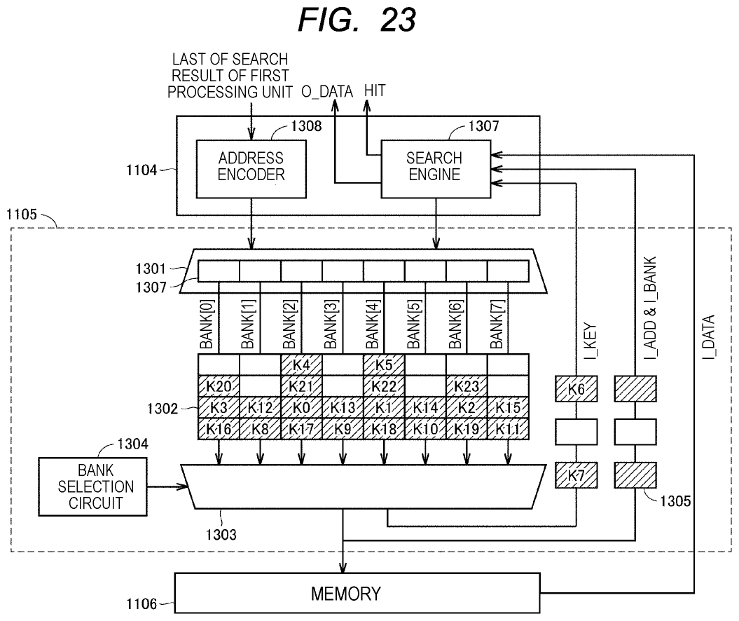

Similar processes are performed for cycles T-88 to T96. FIG. 23 is a diagram for explaining a search operation of a plurality of search keys K0 to K23 according to third embodiment.

Referring to FIG. 23, in this example, a case is shown in which search keys K0 to K23 are continuously input to execute a search operation.

As described above, the search keys K0 to K23 are sequentially stored in FIFO buffers 1302 corresponding to the memory banks BANK[0], BANK[2], BANK[4], and BANK[6], respectively.

The search keys K0 to K5 are stored in FIFO buffers 1302 corresponding to the memory banks BANK[2], BANK[4], BANK[6], and BANK[0] of search stages STAGE[15] according to the search operation.

Further, a case is shown in which new search keys K16 to K23 are continuously input to execute a search operation.

The search key K16 is stored in FIFO buffer 1302 corresponding to the memory bank BANK[0]. The search key K17 is stored in FIFO buffer 1302 corresponding to the memory bank BANK[2]. The search key K18 is stored in FIFO buffer 1302 corresponding to the memory bank BANK[4]. The search keys K19 is stored in FIFO buffer 1302 corresponding to the memory bank BANK[6]. The search key K20 is stored in FIFO buffer 1302 corresponding to the memory bank BANK[0]. The search key K21 is stored in FIFO buffer 1302 corresponding to the memory bank BANK[2]. The search key K22 is stored in FIFO buffer 1302 corresponding to the memory bank BANK[4]. The search key K23 is stored in FIFO buffer 1302 corresponding to the memory bank BANK[6].

Then, the address data input together with the search keys K6 and K7 and the search keys K6 and K7 are stored in the flip-flop (FF) 1305.

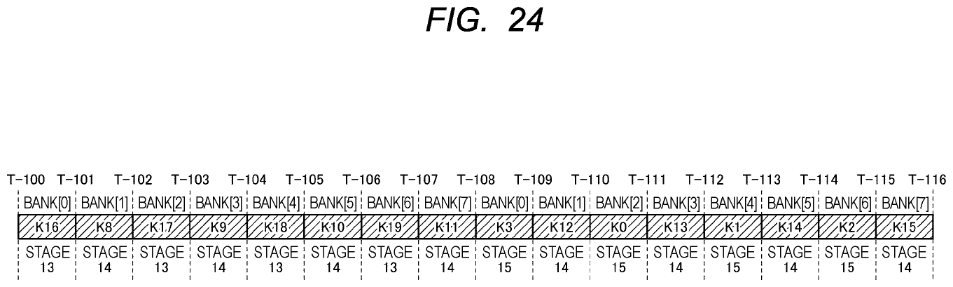

FIG. 24 is a diagram (Part 3) illustrating a timing chart of a search operation of a plurality of search keys according to third embodiment.

Referring to FIG. 24, in T-100 of cycles, the search key K16 is outputted from FIFO buffer 1302 corresponding to the memory bank BANK[0]. As a result, the search operation for the memory bank BANK[0] of the search stage STAGE[13] is executed for the search key K16.

In T-101 of cycles, the search key K8 is outputted from FIFO buffer 1302 corresponding to the memory bank BANK[1]. As a result, the search operation for the memory bank BANK[1] of the search stage STAGE[14] is executed for the search key K8.

In T-102 of cycles, the search key K17 is outputted from FIFO buffer 1302 corresponding to the memory bank BANK[2]. As a result, the search operation for the memory bank BANK[2] of the search stage STAGE[13] is executed with respect to the search key K17.

In T-103 of cycles, the search key K9 is outputted from FIFO buffer 1302 corresponding to the memory bank BANK[3]. As a result, the search operation for the memory bank BANK[3] of the search stage STAGE[14] is executed for the search key K9.

In T-104 of cycles, the search key K18 is outputted from FIFO buffer 1302 corresponding to the memory bank BANK[4]. As a result, the search operation for the memory bank BANK[4] of the search stage STAGE[13] is executed with respect to the search key K18.

In T-105 of cycles, the search key K10 is outputted from FIFO buffer 1302 corresponding to the memory bank BANK[5]. As a result, the search operation for the memory bank BANK[5] of the search stage STAGE[14] is executed for the search key K10.

In T-106 of cycles, the search key K19 is outputted from FIFO buffer 1302 corresponding to the memory bank BANK[6]. As a result, the search operation for the memory bank BANK[6] of the search stage STAGE[13] is executed with respect to the search key K19.

In T-107 of cycles, the search key K11 is outputted from FIFO buffers 1302 corresponding to the memory bank BANK[7]. As a result, the search operation for the memory bank BANK[7] of the search stage STAGE[14] is executed for the search key K11.

In T-108 of cycles, the search key K3 is outputted from FIFO buffer 1302 corresponding to the memory bank BANK[0]. As a result, the search operation for the memory bank BANK[0] of the search stage STAGE[15] is executed for the search key K3.

In T-109 of cycles, the search key K12 is outputted from FIFO buffer 1302 corresponding to the memory bank BANK[1]. As a result, the search operation for the memory bank BANK[1] of the search stage STAGE[14] is executed for the search key K12.

In T-110 of cycles, the search key K0 is outputted from FIFO buffer 1302 corresponding to the memory bank BANK[2]. As a result, the search operation for the memory bank BANK[2] of the search stage STAGE[15] is executed for the search key K0.

In T-111 of cycles, the search key K13 is outputted from FIFO buffers 1302 corresponding to the memory bank BANK[3]. As a result, the search operation for the memory bank BANK[3] of the search stage STAGE[14] is executed for the search key K13.

In T-112 of cycles, the search key K1 is outputted from FIFO buffer 1302 corresponding to the memory bank BANK[4]. As a result, the search operation for the memory bank BANK[4] of the search stage STAGE[15] is executed for the search key K1.

In T-113 of cycles, the search key K14 is outputted from FIFO buffer 1302 corresponding to the memory bank BANK[5]. As a result, the search operation for the memory bank BANK[5] of the search stage STAGE[14] is executed for the search key K14.

In T-114 of cycles, the search key K2 is outputted from FIFO buffer 1302 corresponding to the memory bank BANK[6]. As a result, the search operation for the memory bank BANK[6] of the search stage STAGE[15] is executed for the search key K2.

In T-115 of cycles, the search key K15 is outputted from FIFO buffer 1302 corresponding to the memory bank BANK[7]. As a result, the search operation for the memory bank BANK[7] of the search stage STAGE[14] is executed with respect to the search key K15.

As shown in this method, by sequentially accessing the memory banks BANK[0] to BANK[7] during a search operation, NOP (No Operation) cycles can be suppressed, and an efficient search operation can be performed for a search operation of a plurality of search keys.

### Modified Example

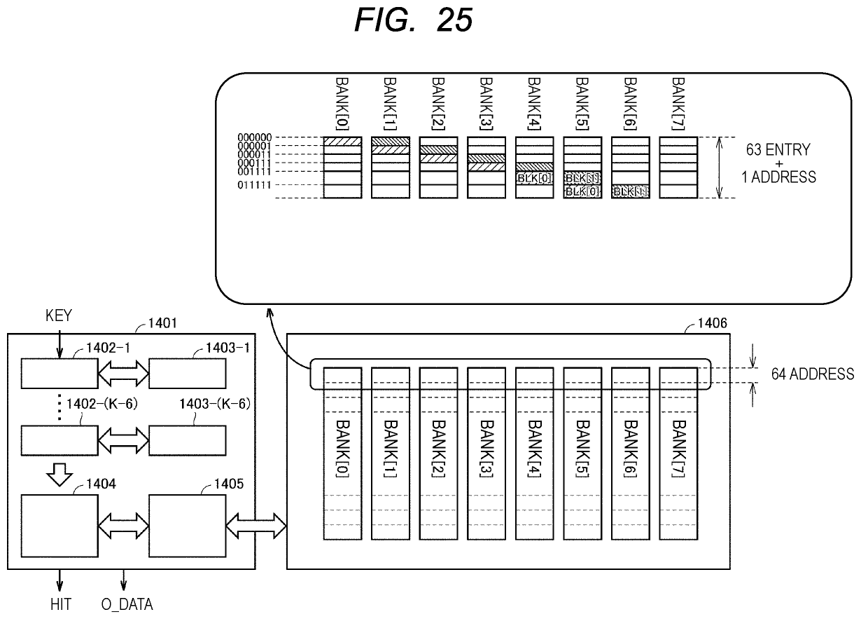

FIG. 25 is a diagram for explaining an outline of search algorithms for binary search according to modified example of third embodiment.

Referring to FIG. 25, the search circuit according to third embodiment includes a processor 1401 and a memory 1406.

The processor 1401 includes a plurality of first processing units 1402-1 to 1402-(K−6), a plurality of built-in memories 1403-1 to 1403-(K−6), a second processing unit 1404, and an interface circuit 1405 for exchanging data between the second processing unit 1404 and the memory 1406. The plurality of first processing units 1402-1 to 1402-(K−6) have the same functions as the plurality of first processing units 502-1 to 502-(K−8) of first embodiment, and their descriptions are omitted.

Then, the determination result of the first processing unit 1402-(K−6) is output to the second processing unit 1404.

The second processing unit 1404 accesses the memory 1406 via the interface circuit 1405 based on the determination result of the first processing unit 1402-(K−6).

The memory 1406 includes a plurality of memory banks. For example, eight memory banks are provided.

In this embodiment, entry data in memory accessing stage (search stages) STAGE[K−5] to STAGE[K] whose number is a smaller than the number of memory banks of the memory 1406, are allocated to the respective memory banks of the memory 1406.

In this configuration, since the search stages STAGE[1] to STAGE[K−6] of the binary search executed by the processor 1401 are pipelined, the binary search can be sequentially executed with a short latency and a throughput of one cycle.

Six memory accesses after the search stage STAGE[K−5] access the memory 1406.

Referring to FIG. 25, in the present embodiment, the group of entry data of 1M addresses is divided into two groups.

The data is divided into a first group of entry data stored in the plurality of built-in memories 1403 and a second group of entry data stored in the memory 1406.

The first group of entry data is stored in the memory 1403. Next, the second group of entry data remaining other than the first group is stored in the memory 1406. The memory 1406 has eight memory banks Bank.

In this embodiment, the remaining entry data group is divided into a plurality of sub-entry data groups grouped according to six search stages. In this example, the data is divided into a plurality of sub-entry data groups BLK[0] to BLK[16383].

One sub-entry data group BLK is composed of 64 pieces of entry data. The entry data of each sub-entry data group BLK corresponds to each of the search stages STAGE[15] to STAGE[20], and the entry data corresponding to the search stages STAGE[15] to STAGE[20] are sequentially stored in the memory banks BANK[0] to BANK[7].

In modified example of third embodiment, in the sub-entry data group BLK[0], entry data corresponding to the search stages STAGE[15] to STAGE[20] are sequentially stored in the memory banks BANK[0] to BANK[5]. In the sub-entry data group BLK[1], entry data corresponding to the search stages STAGE[15] to STAGE[20] are sequentially stored in the memory banks BANK[1] to BANK[6]. In the sub-entry data group BLK[2], entry data corresponding to the search stages STAGE[15] to STAGE[20] are sequentially stored in the memory banks BANK[2] to BANK[7].

The other sub-entry data groups BLKs are stored in the memory banks in the same manner. That is, the entry data of each sub-entry data group BLK is sequentially stored in one of the corresponding memory banks BANK[0] to BANK[7] for each of the search stages STAGE[15] to STAGE[20].

According to this method, it is possible to avoid concentration of entry data in the memory bank corresponding to the subsequent stage of the search stage, and it is possible to smoothen the used capacitances of the respective memory banks. Further, since the corresponding memory banks differ for each of the search stages STAGE[15] to STAGE[20] with respect to the entry data of each sub-entry data group BLK, it is also possible to suppress the deterioration of the search performance due to the waiting time tRC due to the limits on accesses to the same memory bank.

The search performance can be improved by reducing the number of accesses to the memories 1406 in the binary search from 8 to 6.

The following table describes the relationship between the number of stages of the binary search performed by the processor and the number of stages of the binary search performed by using the memory.

TABLE 4

| | number of | number of | | | |
|---|---|---|---|---|---|
| | stages of | entry stored in | | | |
| | binary search | built-in | required | total required | number of |
| | performed by | memory of | memory | capacity of | access times |
| | processor | processor | capacity | memory | to memory |
| Embodiment 1 | 12 | 4K entry | 512K | 4M | 8 cycles |
| Embodiment 2 | 16 | 64K entry | 128K | 1M | 6 cycles |
| Embodiment 3 | 12 | 4K entry | 128K | 1M | 8 cycles |
| Embodiment 3 | 14 | 16K entry | 128K | 1M | 6 cycles |

Here, as shown in the above table, in third embodiment, even if number of search stages allocated to the memory is changed, the memory capacity required to store the search table of the binary search is the same. Therefore, the number of search stages allocated to the memory can be determined by the memory capacity that can be built in the processor.

If the number of search stages processed by the processor is increased, the number of accesses to the memory is decreased, so that the search performance is improved. On the other hand, since the number of entries that must be built in the processor increases, when the processor is realized by ASIC or FPGA, the memory resources are required correspondingly. It is desirable to be able to flexibly change the number of search stages of binary search to be processed in a processor in view of costs, required search performance, and the like.

In the scheme according to first and second embodiments, the number of memory banks in the memory limits the number of search stages allocated to the memory. On the other hand, in the method according to third embodiment, the required memory capacity is not affected by the number of search stages allocated to the memory, and almost 100% of the memory capacity can be used as the search table of the binary search. Therefore, it is desirable to flexibly select the number of search stages to be allocated to the memory so that the load amount of the built-in memory of the processor and the search performance which are contradictory are optimized for the specifications of the products.

### Second Modified Example

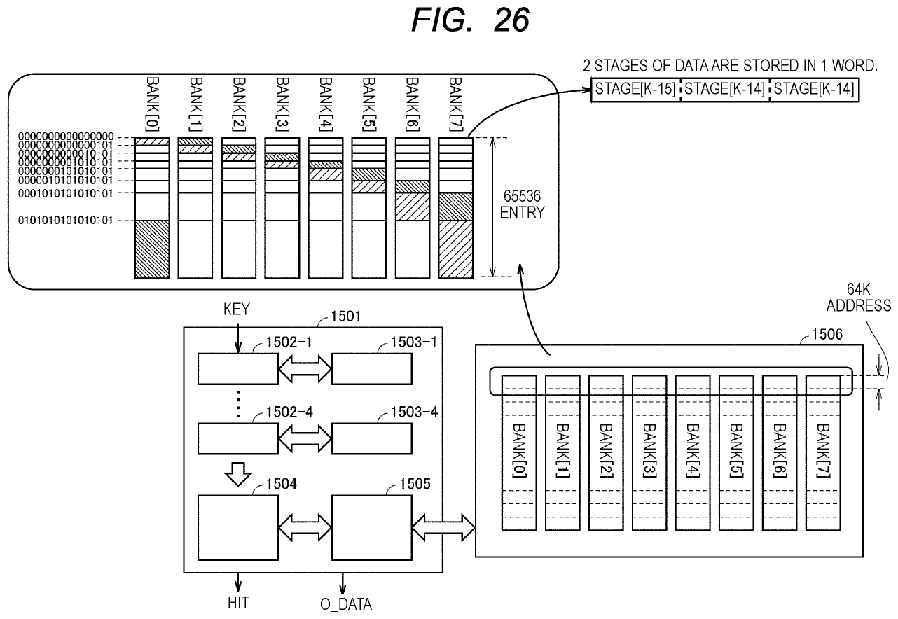

FIG. 26 is a diagram for explaining an outline of search algorithms for binary searches according to second modified example of third embodiment.

Referring to FIG. 26, the search circuit according to second modified example of third embodiment includes a processor 1501 and a memory 1506.

The processor 1501 includes a plurality of first processing units 1502-1 to 1502-4, a plurality of built-in memories 1503-1 to 1503-4, a second processing unit 1504, and an interface circuit 1505 for exchanging data between the second processing unit 1504 and the memory 1506.

The plurality of first processing units 1502-1 to 1502-4 are associated with the plurality of built-in memories 1503-1 to 1503-4, respectively, and constitute pipeline.

Specifically, in response to the input of the search key KEY, the first processing unit 1502 accesses the built-in memory 1503 to determine whether or not the search key KEY matches the data stored in the built-in memory 1503. When it is determined that the search key KEY matches the data, the first processing unit 1502 determines as match (HIT). Then, information associated with the data is output. On the other hand, when it is determined that the search key KEY and the data do not match, the first processing unit 1502 determines that the search key KEY and the data are mismatched (Miss). Then, it outputs the search key KEY together with the determination result to the first processing unit 1502 of the next stage.

The processing is sequentially repeated. The determination result of the first processing unit 1502-4 is output to the second processing unit 1504.

The second processing unit 1504 accesses the memory 1506 via the interface circuit 1505 based on the determination result of the first processing unit 1502-4.

The memory 1506 includes a plurality of memory banks. For example, eight memory banks are provided.

Entry data corresponding to numbers of two search stages is stored corresponding to one entry address allocated to the memory 1506.

For example, it is assumed that the bit width corresponding to one entry address of the memory 1506 is 96 bits or more.

In this case, it is possible to store three pieces of 32-bit entry data. That is, the entry data for two stages of the binary search is stored in the memory cell group corresponding to one entry address.

In this example, the entry data of the number of memory accessing stages (search stages) STAGE[5] to STAGE[20] corresponding to number of memory banks included in the memory 1506 are allocated to the respective memory banks of the memory 1506.

The entry data of the remaining memory accessing stages (search stages) STAGE[1] to STAGE[4] are allocated to the built-in memories 1503-1 to 1503-4 of the processor 1501, respectively.

In this configuration, since the search stages STAGE[1] to STAGE[4] of the binary search executed by the processor 1501 are pipelined, the binary search can be sequentially executed with a short latency and a throughput of one cycle.

Eight memory accesses after the search stage STAGE[5] access the memory 1506.

Referring to FIG. 26, in the present embodiment, the group of entry data of 1M addresses is divided into two groups.

The data is divided into a first group of entry data stored in the plurality of built-in memories 1503 and a second group of entry data stored in the memory 1506.

The entry data of the first group is stored in the memory 1503. Next, the entry data of the second group remaining other than the first group is stored in the memory 1506. The memory 1506 has eight memory banks.

In this embodiment, the remaining entry data group is divided into a plurality of sub-entry data groups grouped according to the eight search stages. In this example, the data is divided into a plurality of sub-entry data groups BLK[0] to BLK[15].

One sub-entry data group BLK is composed of 65536 pieces of entry data. The entry data of each sub-entry data group BLK is sequentially stored in memory banks BANK[0] to BANK[7] corresponding to each search stages.

Specifically, the entry data corresponding to the search stages STAGE[5] and STAGE[6] of the sub-entry data group BLK[0] is stored in the memory bank BANK[0]. The entry data corresponding to the search stages STAGE[7] and STAGE[8] of the sub-entry data group BLK[0] is stored in the memory bank BANK[1]. The entry data corresponding to the search stages STAGE[9] and STAGE[10] of the sub-entry data group BLK[0] is stored in the memory bank BANK[2]. The entry data corresponding to the search stages STAGE[11] and STAGE[12] of the sub-entry data group BLK[0] is stored in the memory bank BANK[3]. The entry data corresponding to the search stages STAGE[13] and STAGE[14] of the sub-entry data group BLK[0] is stored in the memory bank BANK[4]. The entry data corresponding to the search stages STAGE[15] and STAGE[16] of the sub-entry data group BLK[0] is stored in the memory bank BANK[5]. The entry data corresponding to the search stages STAGE[17] and STAGE[18] of the sub-entry data group BLK[0] is stored in the memory bank BANK[6]. The entry data corresponding to the search stages STAGE[19] and STAGE[20] of the sub-entry data group BLK[0] is stored in the memory bank BANK[7].

Similarly, the entry data corresponding to the search stages STAGE[5] to STAGE[18] of the sub-entry data group BLK[1] are sequentially stored in the memory banks BANK[1] to BANK[7]. Then, the entry data corresponding to the search stages STAGE[19] and [20] of the sub-entry data group BLK[1] is stored in the memory bank BANK[0].

Similarly, the memory banks BANK[2] to BANK[7] corresponding to the search stages STAGE[5] to STAGE[16] of the sub-entry data group BLK[2] are sequentially stored. Then, the entry data corresponding to the search stages STAGE[17] and [18] of the sub-entry data group BLK[2] is stored in the memory bank BANK[0]. The entry data corresponding to the search stages STAGE[19] and [20] of the sub-entry data group BLK[2] is stored in the memory bank BANK[1].

The other sub-entry data groups BLKs are stored in the memory banks in the same manner. That is, the entry data of each sub-entry data group BLK is sequentially stored in one of the corresponding memory banks BANK[0] to BANK[7] for each of the search stages STAGE[5] to STAGE[20].

Thus, it is possible to avoid concentration of entry data in the memory bank corresponding to the subsequent stage of the search stages, and it is possible to smoothen the used capacitances of the respective memory banks.

Further, since the corresponding memory bank differs for each of the search stages STAGE[5] to STAGE[20] with respect to the entry data of each sub-entry data group BLK, it is also possible to suppress the deterioration of the search performance due to the waiting time tRC due to the limits on accesses to the same memory bank.

In addition, the built-in memory in the processor 1501 can be reduced in capacity, the memory 1506 can be increased in capacity, and the cost can be reduced.

In addition, since two stages of entry data are stored in one memory bank, the number of memory accesses can be reduced, and the search performance can be improved.

In the above-described embodiment, the above-described processing is executed in the search circuit, but the processing may be executed by cooperation of CPU 2 and the general-purpose memory 6. In addition, the present invention is not particularly limited thereto, and a dedicated circuit can be provided.

Although the present disclosure has been specifically described based on the embodiments described above, the present disclosure is not limited to the embodiments, and it is needless to say that various modifications can be made without departing from the gist thereof.

What is claimed is:

1. A search circuit for determining matching between a search key and a plurality of entry data using binary search, comprising:
a first memory having a plurality of entry data corresponding to a first search stage group out of a plurality of search stages;
a second memory having a plurality of entry data corresponding to a second search stage group out of the search stages, and
a processor performing a binary search operation by using the first memory and the second memory,
wherein the second memory includes a plurality of memory banks provided according to number of the search stages of the second search stage group,
wherein the entry data corresponding to the second search stage group are divided into a plurality of sub-entry data groups for each search stages of the second search stage group,
wherein the entry data of each sub-entry data groups is stored in each the memory banks based on the search stages.

2. The search circuit according to claim 1,
wherein the entry data of each sub-entry data groups is stored in the same memory bank for each same search stage.

3. The search circuit according to claim 1,
wherein the memory banks correspond to each of the search stages, and
wherein the entry data of each sub-entry data groups are stored in a corresponding one of the search stages.

4. The search circuit according to claim 1,
wherein the sub-entry data groups include a first sub-entry data group and a second sub-entry data group, and
wherein entry data of the first sub-entry data group and entry data of the second sub-entry data group are respectively stored in different memory banks for each of the search stages.

5. The search circuit according to claim 1,
wherein the processor accesses the memory banks in order of the search stages.

6. The search circuit according to claim 1,
wherein the processor comprises:
a first processing unit performing the binary search operation for the first memory, and
a second processing unit performing the binary search operation for the second memory according to a binary search result by the first processing unit.

7. The search circuit according to claim 6,
wherein the second processing unit includes an interface circuit for accessing the second memory.

8. The search circuit according to claim 7,
wherein the interface circuit comprises:
a plurality of FIFO buffers each being provided for an associated one of the memory banks and storing the search key and an address information for accessing the associated one of the memory banks, and
a first selection circuit outputting information stored in the FIFO buffers to the second memory while switching the FIFO buffers in order.

9. The search circuit according to claim 8,
wherein the second processing unit includes a determination circuit which determines matching between the entry data read from the second memory and the search key output from the FIFO buffers, and
wherein the interface circuit further includes a second selection circuit which outputs the search key and the address information for accessing a subsequent memory bank of the plurality of memory banks to the associated one of the memory banks according to a determination result by the determination circuit.

10. The search circuit according to claim 1,
wherein the second memory comprises a DRAM.

11. The search circuit according to claim 10,
wherein access to the same memory bank among the plurality of memory banks included in the second memory is prohibited for a predetermined period of time.

12. A search circuit for determining matching between a search key and a plurality of entry data according to a binary search operation, comprising:
a first processing unit performing a first binary search operation for at least one of first search stages out of search stages of the binary search operation;
a second processing unit coupled in series to the first processing unit and performing a second binary search operation for a plurality of second search stages of search stages of the binary search operation in response to a search result of the first binary search operation, and
a memory including a plurality of memory banks, the memory banks each storing entry data of the corresponding one of the second search stages,
wherein the second processing unit performs the second binary search operation while accessing the memory.
